(19) United States
(12) Patent Application Publication
(10) Pub. No.: US 2023/0340919 A1
(43) Pub. Date: Oct. 26, 2023

(54) Systems, Devices and Methods for Rich Engine Control

(71) Applicant: M2X Energy, Inc., Rockledge, FL (US)

(72) Inventors: Kyle I. Mercal, Winston-Salem, NC (US); John Anthony Dean, Scotia, NY (US); Paul E. Yelvington, Rockledge, FL (US); Joshua B. Browne, New York, NY (US)

(73) Assignee: M2X Energy, Inc., Rockledge, FL (US)

(21) Appl. No.: 18/161,059

(22) Filed: Jan. 28, 2023

Related U.S. Application Data
(63) Continuation-in-part of application No. 17/746,942, filed on May 17, 2022, now Pat. No. 11,649,201.
Application No. 17/746,942 is a continuation-in-part of application No. 17/953,056, filed on Sep. 26, 2022.
Application No. 17/953,056 is a continuation-in-part of application No. 17/984,126, filed on Nov. 9, 2022.
(60) Provisional application No. 63/304,463, filed on Jan. 28, 2022.
(60) Provisional application No. 63/304,471, filed on Jan. 28, 2022.
(60) Provisional application No. 63/304,475, filed on Jan. 28, 2022.
(60) Provisional application No. 63/189,756, filed on May 18, 2021.
(60) Provisional application No. 63/213,129, filed on Jun. 21, 2021.
(60) Provisional application No. 63/197,898, filed on Jun. 7, 2021.
(60) Provisional application No. 63/248,519, filed on Sep. 26, 2021.
(60) Provisional application No. 63/277,522, filed on Nov. 9, 2021.

(51) Int. Cl. F02D 41/14; F02M 21/02; F02D 41/00; F02B 75/04; F02B 75/24; F02B 43/10

(52) U.S. Cl. CPC F02D 41/1454; F02M 21/0209; F02M 21/0227; F02D 41/0027; F02B 75/047; F02B 75/24; F02B 75/045; F02D 41/0002; F02B 43/10; F02B 2075/025

(57) ABSTRACT

There are provided systems and methods for using fuel rich partial oxidation to produce an end product from waste gases, such as flare gas. Lambda sensor modifications and other control parameters that provide closed-loop mixture control at extremely fuel-rich operating conditions utilizing feed-forward and feedback approaches, physics-based engine models, novel use of a lambda sensor (O₂-based sensor), sensors with intermittent contact with the gas stream. In an embodiment the system and method use air-breathing engines having control systems, control parameters, sensors and input/output (I/O) for the fuel rich (ER of 1.2 and greater), partial oxidation of the flare gas to form syngas. In embodiments the syngas is further converted into an end product. In an embodiment the end product is methanol.

This application: (i) claims under 35 U.S.C. § 119(e)(1) the benefit of the filing date of, and claims the benefit of priority to, U.S. provisional application Ser. No. 63/304,471, filed Jan. 28, 2022; (ii) is a continuation in part of U.S. application Ser. No. 17/746,942, filed May 17, 2022, which claims under 35 U.S.C. § 119(e)(1) the benefit of the filing date of, and claims the benefit of priority to, U.S. provisional application Ser. No. 63/189,756 filed May 18, 2021, 63/213,129 filed Jun. 21, 2021, and 63/197,898 filed Jun. 7, 2021; (iii) is a continuation in part of U.S. application Ser. No. 17/953,056, filed Sep. 26, 2022, which claims under 35 U.S.C. § 119(e)(1) the benefit of the filing date of, and claims the benefit of priority to, U.S. provisional application Ser. No. 63/248,519, filed Sep. 26, 2021; (iv) is a continuation in part of U.S. application Ser. No. 17/984,126, filed Nov. 9, 2022, which claims under 35 U.S.C. § 119(e)(1) the benefit of the filing date of, and claims the benefit of priority to, U.S. provisional application Ser. No. 63/277,522 filed Nov. 9, 2021; (v) claims under 35 U.S.C. § 119(e)(1) the benefit of the filing date of, and claims the benefit of priority to, U.S. provisional application Ser. No. 63/304,463, filed Jan. 28, 2022; and, (vi) claims under 35 U.S.C. § 119(e)(1) the benefit of the filing date of, and claims the benefit of priority to, U.S. provisional application Ser. No. 63/304,475, filed Jan. 28, 2022, the entire disclosure of each of which is incorporated herein by reference.

### BACKGROUND OF THE INVENTION

### Field of the Invention

The present inventions relate to new and improved methods, devices and systems for recovering and converting flare gas into useful and economically viable materials. In particular, the present inventions relate to new and improved methods, devices and systems for operating and controlling engines, in particular air-breathing reformers, for use in gas-to-liquids systems and processes.

In particular, the present inventions relate to new and improved methods, devices and systems for operating engines, in particular air-breathing reformers, for use in gas-to-liquids systems and processes.

The term “flare gas”, “waste gas” and similar such terms should be given their broadest possible meaning, and would include gas generated, created, associated or produced by or from oil and gas production, hydrocarbon wells (including conventional and unconventional wells), petrochemical processing, refining, landfills, wastewater treatment, dairies, livestock production, and other municipal, chemical and industrial processes. Thus, for example, flare gas and waste gas would include stranded gas, associated gas, landfill gas, vented gas, biogas, digester gas, small-pocket gas, and remote gas.

Typically, the composition of flare gas is a mixture of different gases. The composition can depend upon the source of the flare gas. For instance, gases released during oil-gas production mainly contain natural gas. Natural gas is more than 90% methane (CH₄) with ethane and smaller amounts of other hydrocarbons, water, N₂ and CO₂ may also be present. Flare gas from refineries and other chemical or manufacturing operations typically can be a mixture of hydrocarbons and in some cases H₂. Landfill gas, biogas or digester gas typically can be a mixture of CH₄ and CO₂, as well as small amounts of other inert gases. In general, flare gas can contain one or more of the following gases: methane, ethane, propane, n-butane, isobutane, n-pentane, isopentane, n-hexane, ethylene, propylene, 1-butene, carbon monoxide, carbon dioxide, hydrogen sulfide, hydrogen, oxygen, nitrogen, and water.

The majority of flare gas is produced from smaller, individual point sources, such as a number of oil or gas wells in an oil field, a landfill, or a chemical plant. Prior to the present inventions flare gas, and in particular flare gas generated from hydrocarbon producing wells, and other smaller point sources, was burned to destroy it, in some instances may have been vented directly into the atmosphere. This flare gas could not be economically recovered and used. The burning or venting of flare gas, both from hydrocarbon production and other endeavors, raises serious concerns about pollution and the production of greenhouse gases.

As used herein unless specified otherwise, the terms “syngas” and “synthesis gas” and similar such terms should be given their broadest possible meaning and would include gases having as their primary components a mixture of H₂ and CO; and may also contain CO₂, N₂, and water, as well as, small amounts of other materials.

As used herein unless specified otherwise, the term “product gas” and similar such terms should be given their broadest possible meaning and would include gases having H₂, CO and other hydrocarbons, and typically significant amounts of other hydrocarbons, such as methane.

As used herein unless specified otherwise, the term “reprocessed gas” includes “syngas”, “synthesis gas” and “product gas”.

As used herein unless specified otherwise, the terms “partial oxidation”, “partially oxidizing” and similar such terms mean a chemical reaction where a sub-stoichiometric mixture of fuel and air (i.e., fuel-rich mixture) is partially reacted (e.g., combusted) to produce a syngas. The term partial oxidation includes both thermal partial oxidation (TPOX), which typically occurs in a non-catalytic reformer, and catalytic partial oxidation (CPOX). The general formula for a partial oxidation reaction is

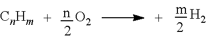

As used herein the terms “rich”, “rich fuel mixture”, “rich operation”, “rich burn” and similar such terms mean that the fuel-air mixture has an overall fuel/air equivalence ratio (ϕ or ER) from about 1.5 to about 5, from about 1.5 to about 2.5, from about 1.2 to about 4.0, from about 2 to about 4.5, about 1.5, about 2, greater than about 1.5, greater than 2, greater than 2.5, greater than 3 and greater than 3.5.

As used herein the terms “lean”, “lean fuel mixture”, “lean operation”, “lean burn” and similar such terms mean that the fuel-air mixture has an overall fuel/air equivalence ratio (ϕ or ER) of less than 1.35.

As used herein unless specified otherwise, the recitation of ranges of values herein is merely intended to serve as a shorthand method of referring individually to each separate value falling within the range. Unless otherwise indicated herein, each individual value within a range is incorporated into the specification as if it were individually recited herein.

Generally, the term “about” as used herein unless stated otherwise is meant to encompass the larger of a variance or range of ±10%, or the experimental or instrument error associated with obtaining the stated value.

As used herein unless specified otherwise, the term “CO₂e” is used to define carbon dioxide equivalence of other, more potent greenhouse gases, to carbon dioxide (e.g., methane and nitrous oxide) on a global warming potential basis of 20 or 100 years, based on Intergovernmental Panel on Climate Change (IPCC) Fifth Assessment Report (AR5) methodology. The term “carbon intensity” is taken to mean the lifecycle CO₂e generated per unit mass of a product.

As used herein, unless specified otherwise, the term “crude methanol” is defined as methanol produced in a methanol synthesis loop prior to the removal of water, dissolved gases, or other contaminants. Crude methanol often contains 5-20 wt % water, dissolved gases (e.g., 1-2 wt % CO₂) and trace contaminants (e.g., ethanol). As used herein, unless specified otherwise, the term “stabilized methanol” is defined as crude methanol that has passed through a flash operation (e.g., a single-stage flash drum) to reduce the concentration of dissolved gases and other light components. Often stabilized methanol will have <1% CO₂ and most typically about 0.5 wt % CO₂. As used herein, the terms “source methanol”, “initial methanol”, or similar terms refer to “crude methanol”, “stabilized methanol” or both. As used herein, the term “grade methanol” is defined as methanol that meets a purity standard such as the ASTM AA standard (D1152) or IMPCA methanol reference specifications.

As used herein, unless specified otherwise, the terms % and mol % are used interchangeably and refer to the moles of a first component as a percentage of the moles of the total, e.g., formulation, mixture, material or product.

As used herein, unless specified otherwise the terms weight % (wt %) and mass % refer to the weight of a first component as a percentage of the weight of the total, e.g., formulation, mixture, material or product.

As used herein, unless stated otherwise, room temperature is 25° C., and standard temperature and pressure is 15° C. and 1 atmosphere (1.01325 bar). Unless expressly stated otherwise all tests, test results, physical properties, and values that are temperature dependent, pressure dependent, or both, are provided at standard temperature and pressure.

As used herein, unless stated otherwise, the terms “fuel-to-air equivalence ratio”, “equivalence ratio”, “fuel/air equivalence ratio”, “0” or “ER”, and similar such terms have the same meaning and are to be given their broadest meaning and would include the ratio of the actual fuel/air ratio to the stoichiometric fuel/air ratio. The stoichiometric air/fuel ratio is that needed for ideal, stoichiometric combustion to occur, which is when all the fuel and oxygen is consumed in the reaction, and the products are carbon dioxide and water.

This Background of the Invention section is intended to introduce various aspects of the art, which may be associated with embodiments of the present inventions. Thus, the forgoing discussion in this section provides a framework for better understanding the present inventions, and is not to be viewed as an admission of prior art.

### SUMMARY

There has been a long-standing, expanding and unmet need for systems, devices and methods to convert otherwise uneconomic hydrocarbon-based fuel (e.g., stranded, associated, non-associated, landfill, flared, small-pocket, remote gas, waste water treatment) to value-added, easily transported products (such as methanol, ethanol, ammonia, dimethyl-ether, F-T liquids, and other fuels or chemicals). There has been a continuing need for improved systems and methods to control engine operation, in particular, when air-breathing engines are operated under rich conditions, as well as, when such engines and operation are used as reformers in such systems, devices and methods to convert otherwise uneconomical hydrocarbon-based fuel into value-added, easily transported products. The present inventions, among other things, solve these needs by providing the articles of manufacture, devices and processes taught, and disclosed herein.

Thus, there is provided a spark ignited reciprocating engine for a rich mixture of hydrocarbon fuel and air that when burned produces a syngas that can be used in a downstream process; wherein the engine includes a control system having a controller, a memory and control program defining an engine control strategy to enable operation under rich conditions; wherein the control system includes sensors to monitor the fuel-air ratio; an algorithm to take the input from the sensors and determine control actions to maintain engine operation from start-up to steady operation at desired output to shut down; and actuators to implement the actions required by the control algorithm.

Additionally, there is provided for a gas-to-liquid reformer sensor to monitor the fuel-air ratio, wherein the sensors are located at an inlet to the engine and including monitoring air mass, fuel mass flow and fuel composition; wherein this fuel composition sensor, includes a means to determine the speciation of hydrocarbons, which can be measured with a gas chromatograph (GC), thermal conductivity detector (TCD), a flame Ionization detector (FID) and combinations of these.

In addition, there is provided a gas-to-liquid reformer sensor at the exhaust of the engine to measure gaseous products of combustion including CO₂, CO and H₂.

Still further there is provided a gas-to-liquid reformer using the method of back-calculating any of this sensor obtained data.

Yet further, there is provided a gas-to-liquid reformer having a “Lambda sensor” (also known as an Oxygen sensor), based on the principle of catalytic transformation, that is specially designed, calibrated and tuned for rich operation.

Moreover, there is provided for a gas-to-liquid reformer having sensors to monitor satisfactory engine operation, including to detect engine knock, “Knock sensors”, in the form of dynamic pressure sensors or accelerometers on the cylinder head, and to detect engine misfire, monitor engine speed via a shaft encoder, hall effect sensor, or equivalent.

In addition, there is provided a closed-loop engine control strategy algorithm including engine speed, spark timing and knock detection to handle variation in fuel properties, comprising an outer control loop sets parameters for steady operation and to achieve desired production of syngas: some parameters are fixed including the engine speed and the fully open throttle. In response to changes in external factors such as fuel composition and ambient temperature, self-adjusting calibration factors are varied to maintain constant engine power production (and thus engine speed), while the fuel-air ratio is maintained at a level to achieve desired H₂/CO ratio and overall conversion to syngas.

Still further there is provided these systems, control systems and methods of operation having one or more of the following features: wherein engine speed is held constant while inlet parameters such as composition and density vary via spark timing, intake pressure (boost), and/or cylinder deactivation; wherein engine load vary but maintain engine speed by employing a variable load bank; wherein spark timing control of engine speed is achieved by calibrating the engine for nominal operation at a spark timing retarded from MBT (minimum spark advance for best torque); wherein as engine power decreases, output power, and thus engine speed, can be restored quickly by advancing spark timing towards MBT; wherein as engine power increases, output power, and thus engine speed, can be restored quickly by further retarding spark timing from MBT.

Moreover, there is provided these systems, control systems and methods of operation having one or more of the following features: wherein intake boost control of engine speed is achieved by calibrating the engine for nominal operation at less than maximum boost using a variable boost turbocharger or supercharger; wherein as engine power decreases, output power, and thus engine speed, can be restored quickly by increasing boost pressure towards the system maximum; wherein if engine speed increases, output power, and thus engine speed, can be decreased quickly by further decreasing boost pressure from the system maximum; wherein cylinder deactivation is achieved by disabling engine intake valve operation in one or more cylinders of the engine while operating; wherein engine output is decreased proportional to the number of cylinders deactivated; wherein cylinder deactivation is appropriate when significant changes in load are desired, with spark timing and intake boost performing smaller ‘trim’ functions.

Yet additionally, there is provided these systems, control systems and methods of operation having one or more of the following features: wherein there is a means of maintaining engine speed is to allow engine power production to vary but employ a rapidly variable load to compensate; wherein the load bank control of engine speed is achieved by attaching a load bank with variable resistance to the output shaft of the engine; wherein as engine speed drops, resistance of the load bank can be decreased rapidly to restore engine speed to the desired value; wherein as engine speed increases, resistance of the load bank can be increased rapidly to restore engine speed to the desired value.

Furthermore, there is provided these systems, control systems and methods of operation having one or more of the following features, wherein an inner control loop senses boundaries of engine operation such as: misfire (poor combustion resulting in reduced torque at shaft and thus reduced speed if load unchanged) or knock (abnormal combustion of unburned end gases); a high bandwidth response of the control system is to vary spark timing in response to these undesirable combustion phenomena; a second control loop manages the manifold air temperature in response to engine operation (knock or misfire), in response to ambient temperature, or in response to fuel composition; wherein the reactivity of the composition of the inlet gas mixture including reduced nitrogen concentration is changed; wherein the addition of a reactive gas such as hydrogen or methanol, or add water; wherein when limits of engine speed control are reached via spark timing, intake boost, and/or load bank control, target fuel-air ratio (equivalence ratio) can be varied.

Thus, there is provided a method of converting a gas to an end product, the method includes: receiving a flow of a hydrocarbon-based fuel source, where the composition is primarily gaseous hydrocarbons and inert gases from a source; processing the fuel source in a fuel conditioning system to remove liquids and contaminants harmful to a downstream component, thereby providing a conditioned fuel source; partially oxidizing the conditioned fuel source in a rich-burn, air-breathing reciprocating engine to produce a syngas mixture with a H₂/CO ratio suitable for synthesis of liquids; the reciprocating engine including: a sensor system to detect ignition/combustion behavior over a range from pre-ignition to misfire; and, a fast-acting control system in control communication with the sensor system, configured to operate the engine under rich fuel conditions.

Further, there is provided a system for converting a gas to an end product, the system includes: an inflow port for receiving a flow of a hydrocarbon-based fuel source, where the composition is primarily gaseous hydrocarbons and inert gases from a source; the inflow port in fluid commination with a fuel conditioning system to remove liquids and contaminants harmful to a downstream component, thereby providing a conditioned fuel source; the fuel conditioning system in fluid communication with a rich-burn, air-breathing reciprocating engine, whereby the engine is configured to partially oxidize the conditioned fuel source to produce a syngas mixture with a H₂/CO ratio suitable for synthesis of liquids; the reciprocating engine including a means to control operation under rich burning fuel conditions.

Moreover, there is provided these systems and methods having one or more of the following features: wherein the hydrocarbon-based fuel source is a flare gas or non-economic gas; wherein the engine is a compression ignition engine including a diesel cycle engine, or homogeneous charge compression ignition engine; wherein the engine is a spark ignition engine including an otto cycle; wherein the engine is an opposed-piston linear-free-piston internal combustion engine; wherein the engine is a crankshaft-driven opposed-piston internal combustion engine with a crankshaft phaser to rotate the phasing of one piston relative to the other thereby modifying overall compression ratio; wherein the engine is a conventional spark-ignited reciprocating engine that achieves variable ‘effective’ compression ratio utilizing camshaft phasers to rotate the intake and exhaust camshafts to affect valve opening and closing; wherein the engine is a conventional spark-ignited reciprocating engine that achieves variable ‘effective’ compression ratio utilizing a variable lift and/or duration valvetrain to affect valve opening and closing; wherein the engine includes a multi-link system in place of a traditional connecting rod to rotate the crankshaft, and an actuator motor changes the multi-link system endpoint; wherein the engine is a 2-stroke engine; wherein a 4-stroke engine; wherein the engine speed is varied together with engine compression ratio to achieve desired combustion phasing and desired exhaust gas composition; wherein the inlet manifold air temperature is varied together with engine compression ratio to achieve desired combustion phasing and desired exhaust gas composition; wherein the inlet manifold air pressure (e.g., boost level) is varied together with engine compression ratio to achieve desired combustion phasing and desired exhaust gas composition; wherein steam or hydrogen is added to the incoming air or fuel and the amount of addition is varied together with engine compression ratio to achieve desired combustion phasing and desired exhaust gas composition; wherein the control system uses one or more of feedback control, feed-forward control or model-based control using a physics-based engine model; where the engine is operated under an ER of at least 1.5; where the engine is operated under an ER of at least about 2; where the engine is operated under an ER of at least about 2.5; where the engine is operated under an ER of at least about 3; where the engine is operated under an ER of from about at least about 2.5; wherein a compression ratio is controlled between a ratio of 8:1 to 14:1; wherein downstream of the syngas engine is a combination of integrated heat exchangers, compression system components, and heat exchangers to prepare the syngas for the downstream synthesis reactors; wherein downstream of the syngas engine there is a downstream synthesis reactor system to produce useful liquid products; wherein downstream of the syngas engine there is a downstream synthesis reactor system to produce useful gaseous products; wherein a cloud-based remote monitoring system, including AI-trained anomaly detection, to dynamically monitor engine data to assess and respond to fuel supply anomalies.

Moreover, there is provided these systems and methods having one or more of the following features: wherein from a CO₂e life-cycle-assessment perspective, results in negative CO₂e emissions of about 40 kg CO₂e per kg of end product (in this case, liquid methanol), compared to baseline liquid methanol production from pipeline natural gas, when produced from flare gas; wherein the resulting negative CO₂e emissions are about 70 kg CO₂e per kg of end product (methanol) when produced from flare gas and displacing an equivalent kg of baseline methanol from pipeline natural gas; wherein the resulting negative CO₂e emissions are about 130 kg CO₂e per kg of end product (methanol) when produced from flare gas and displacing an equivalent kg of baseline methanol from coal gasification; wherein the end product includes methanol; wherein the end product includes a material selected for the group consisting of ethanol, mixed alcohols, ammonia, dimethyl-ether, and F-T liquids.

Yet further, there is provided these systems and methods having one or more of the following features: wherein the source of the flare gas is a hydrocarbon well; wherein the source of the flare gas is an oil well; wherein the source of the flare gas is an unconventional oil well; wherein the source of the flare gas is selected from the group consisting of petrochemical processing, refining, landfills, wastewater treatment, and livestock; wherein the flow of the flare gas from the source is at a rate of about 300,000 scfd to about 30,000,000 scfd; wherein the flow of the flare gas from the source is at a rate of about 50,000 scfd to about 300,000 scfd; wherein the flow of the flare gas from the source is at a rate of about 500,000 scfd to about 20,000,000 scfd; wherein the flow of the flare gas from the source is at a rate of about 600,000 scfd to about 15,000,000 scfd; wherein the flow of the flare gas from the source is at a rate of about 700,000 scfd to about 10,000,000 scfd; wherein the gas conditioning system removes iron sulfides; wherein the flare gas conditioning system removes H₂S; and wherein the gas conditioning system removes sulfur containing compounds.

Still further, there is provided these systems and methods having one or more of the following features: wherein the engine has a variable compression ratio.

### BRIEF DESCRIPTION OF THE DRAWINGS

FIG. 1 is a T-S diagram of embodiments of the thermodynamic state points for converting waste, e.g., flare gas to syngas to value added products using an embodiment of an air-breathing process in accordance with the present inventions.

FIG. 2 is a schematic flow diagram of an embodiment of a system and process in accordance with the present inventions.

FIG. 3 is a T-S diagram showing an embodiment of a process, operating conditions and thermodynamic state points for converting flag gas to syngas to methanol, using the system of FIG. 2 having a spark ignition reciprocating engine in accordance with the present inventions.

FIG. 4 is a T-S diagram showing an embodiment of a process, operating conditions and thermodynamic state points for converting flag gas to syngas to methanol, using the system of FIG. 3 having a compression ignition reciprocating engine in accordance with the present inventions.

FIG. 5A is a pie chart showing the composition of an embodiment of a lean flare gas that can be processed by the present systems and methods in accordance with the present inventions.

FIG. 5B is a pie chart showing the composition of an embodiment of a rich flare gas that can be processed by the present systems and methods in accordance with the present inventions.

FIG. 6 is a graph showing the Wobbe number versus fuel heating value for various components and variations of flare gas that can be processed by embodiments of the present systems and methods in accordance with the present inventions.

FIG. 7 is a cross sectional view of an opposed-piston internal combustion reciprocating reformer engine in accordance with the present inventions.

FIG. 8 is a graph comparing the displaced volumes of an opposed piston engine reformer in accordance with the present inventions.

FIG. 9A is a cross section view of embodiments of an engine reformer in accordance with the present inventions.

FIG. 9B is a cross sectional view of an embodiment of a variable compression engine reformer, showing the piston heights, in accordance with the present inventions.

FIG. 10 is a table showing an embodiment of a start-up control strategy and method of operation provided by an embodiment of a control system in accordance with the present inventions.

FIG. 11 is a cross sectional schematic of an embodiment of a bypass system for intermittent sensor exposure in accordance with the present inventions.

FIG. 12 is a Venn diagram illustrating examples of the benefits obtained by an embodiment of engine operation attributes in accordance with the present inventions.

FIGS. 13A and 13B are schematic flow diagrams of an embodiment of a flare gas to methanol system and process having a reformer stage and a methanol syntheses stage in accordance with the present inventions. FIG. 13A shows the reformer stage and FIG. 13B shows the methanol stage.

FIGS. 14A to 14D are graphs showing an embodiment of the step response of a variable resistance load bank based engine speed control in accordance with the present inventions.

### DESCRIPTION OF THE PREFERRED EMBODIMENTS

The present inventions generally relate to systems, devices and methods to recover in an economical fashion usable fuels from flare gas, and in particular, in an embodiment, to achieve such recovery at smaller, isolated or remote locations or point sources for the flare gas.

In general embodiments of the present inventions relate to systems and methods having gas-to-liquids systems and processes, e.g., for processing flare gas to methanol. In these systems an air-breathing engine reformer produces a syngas intermediate that is further converted to methanol in a downstream synthesis step. Examples of these gas-to-liquid systems are taught and disclosed in US patent publication no. 2022/0388930 and in U.S. patent application Ser. No. 17/953,056 (filed Sep. 26, 2022), the entire disclosure of each of which is incorporated herein by reference. In particular, embodiments of the present invention relate to devices, systems and methods to manage and improve the operation of rich burning reciprocating engines that are the reformers for these types of gas-to-liquid systems.

In general, embodiments of the present systems may also have a CO₂ separator that receives a gas-phase stream and separates this stream into two streams, a CO₂ rich stream and a CO₂ depleted stream. The systems may further have a Hydrogen separator that receive a gas-phase stream and separates that stream into a Hydrogen rich stream and a Hydrogen depleted stream. The CO₂ rich stream can be used for use in EOR (enhanced oil recovery), storage, sold as a product, and combinations and variations of these.

Although this specification focusses on methanol synthesis as an example, it is understood that the present methods and systems have applicability to other similar downstream synthesis processes. Thus, and in general, embodiments of the present methods and system find application in, and can be used with or in conjunction with, systems and methods for the convert otherwise uneconomic hydrocarbon-based fuel (e.g., stranded, associated, landfill, flared, small-pocket, remote gas) to value-added, easily transported products (such as methanol, ethanol, ammonia, dimethyl-ether, F-T liquids, and other fuels or chemicals) using an autonomous, modular system.

Embodiments of these gas-to-liquid systems for the conversion of uneconomical hydrocarbon fuel use an air-breathing, reciprocating engine as a reformer. Preferred operation of these engines in the gas-to-liquid systems is under rich conditions. Prior to the recent developments by the inventors, however, engine control and operability under such rich conditions was difficult, problematic and not commercially viable, and for all practical purposes not obtainable. Thus, embodiments of the present inventions further improve upon the control and operation of rich operating condition engines used as reformers in gas-to-liquid systems, including systems of the type described and taught in US patent publication no. 2022/0388930. Such rich fuel-air mixtures are required to produce syngas with a desirable H₂/CO ratio. Conventional engine control systems are designed for stochiometric or lean burn engines, thus they cannot effectively control the engine for the purpose of providing syngas with the desirable H₂/CO ratio. Thus, an embodiment of the present inventions, and a solution to this problem, involves one, or more, or all of feed-forward and feedback approaches, physics-based engine model, novel use of a lambda sensor (O₂-based sensor), sensors with intermittent contact with the gas stream, and combinations and variations of these.

The embodiments of the present inventions having a reciprocating engine to produce reprocessed gas, preferably syngas, are advantageous under certain circumstances. Embodiments of the present systems can be modular and can easily and readily be positioned at difficult to access locations, locations with limited area for placement of the systems, and combinations and variations of these, where flare gas is generated.

An objective of embodiments of the present inventions is to convert otherwise uneconomic hydrocarbon-based fuel (e.g., stranded, associated, landfill, flared, small-pocket, remote gas) to value-added, easily transported products (such as methanol, ethanol, ammonia, dimethyl-ether, F-T liquids, and other fuels or chemicals) using an autonomous, modular system.

Embodiments of the present inventions focus on reciprocating engines and methods of operating those engines to handle the variable combustion properties of the fuel sources, including fuel sources from an oil field, such as flare gas. One of the reasons that these gases are non-economic is that the fuel composition is highly variable. A consequence of composition variation is the resulting effect on combustion properties such as: heating value, cetane number (delay in time of ignition of fuel), and octane number (resistance to pre-ignition due to compression). These variations can occur from source-to-source, from day-to-day at the same source (transients), from season-to-season (particularly bio-gases), and over time as the source ages.

Conventional air-breathing reciprocating engines typically are designed to operate using fuels with a narrow fuel specification. For example, the compression ratio of automotive gasoline engines is selected for the quality of fuel used. The “regular” gasoline in the United States has an octane rating of 86-87. A higher performance (e.g., higher compression ratio) engine may require premium gasoline with octane rating of 91-94.

An embodiment of the present invention is the configuration, operation and both, of a commercial reciprocating engine (e.g., off the shelf engine) for the production of syngas by operating the engine at rich conditions with high fuel-to-air ratio (equivalence ratio in the range 1.5 to 2.5). To allow the engine to operate off-design from its intended design point, and to operate satisfactorily using fuel that varies over a wide range of octane and cetane numbers, these embodiments modify operating engine parameters including for example compression ratio, inlet manifold air temperature, inlet manifold air pressure, and engine speed. These embodiments apply to both compression ignition engines (diesel cycle) and spark ignition engines (otto cycle). For spark ignition engines, the spark timing can also be used to adapt the engine operation to fuel variation.

Embodiments of the present inventions can be used to take uneconomic hydrocarbon-based fuels at a well-head and remote locations that are primarily gaseous hydrocarbons and convert them to a more valuable easily condensable or liquid compounds, such as methanol. One source of fuel could be associated gas or flare gas, which is produced as a byproduct at oil wells. Another source is flare gas produced by industrial processes, such as refinery flare gas. Another source could be biogas from landfill or anaerobic digesters.

Embodiments of the present inventions are particularly useful in small-scale plants, using one or a plurality of syngas engines, targeting 600,000 scfd (standard cubic feet per day) of inlet gas. The size of such a plant could vary from 80,000 scfd to 3,000,000 scfd, or 20,000 scfd to 100,000 scfd.

Embodiments of the present inventions can be incorporated into one or more modular, interconnected skids or containers that are built at a central fabricator shop location and then installed at a field location. A small number of modules comprise the system and when connected at site they form an integrated system. The modular nature of the assembly enables application to remote locations under a range of inlet gas feed volumes, with a minimum of field labor.

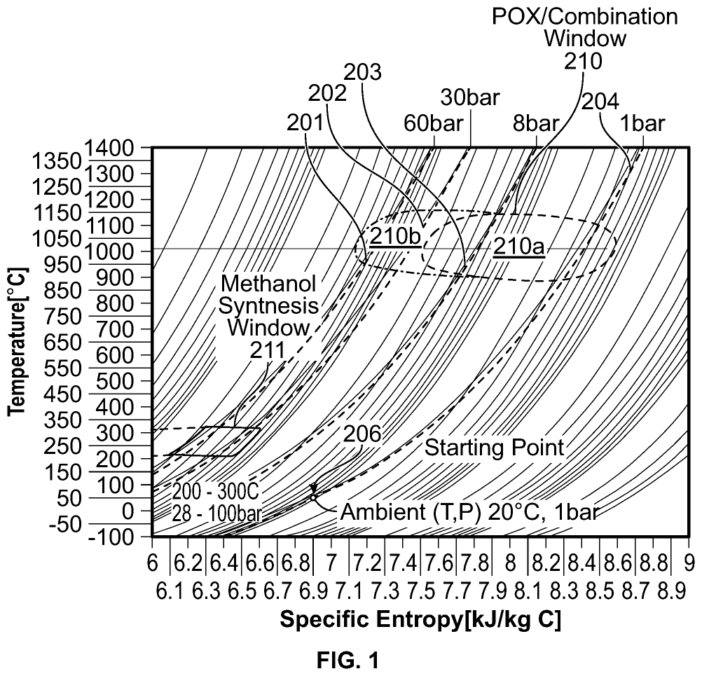

The overall general conversion process from fuel to useful product can a described using a T-S diagram, using properties of air, in an air standard approximation of the process. FIG. 1 describes the conditions (temperature, entropy, pressure, etc.) where the key processes of syngas production and synthesis of products occurs.

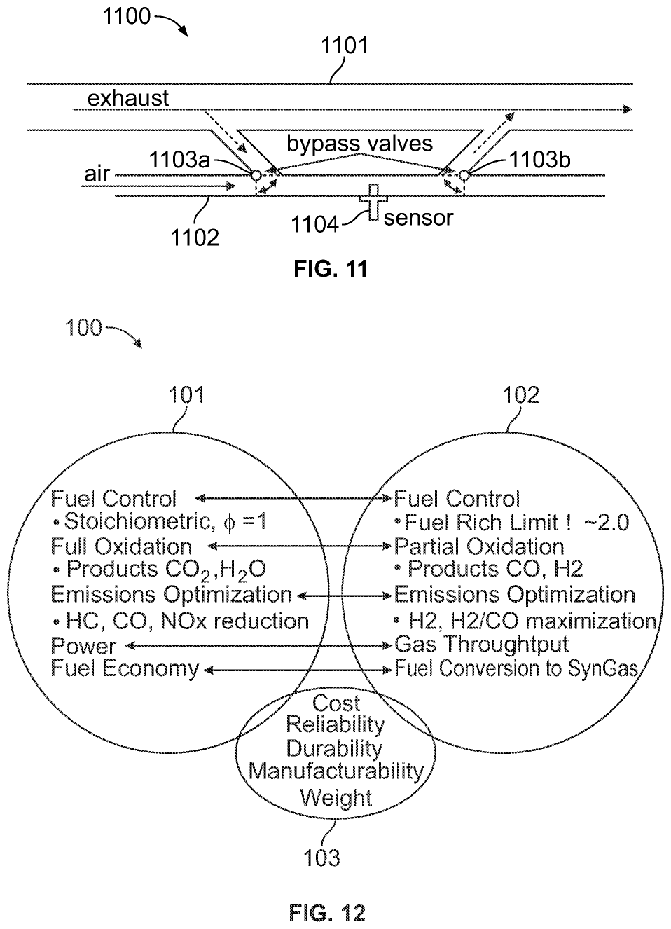

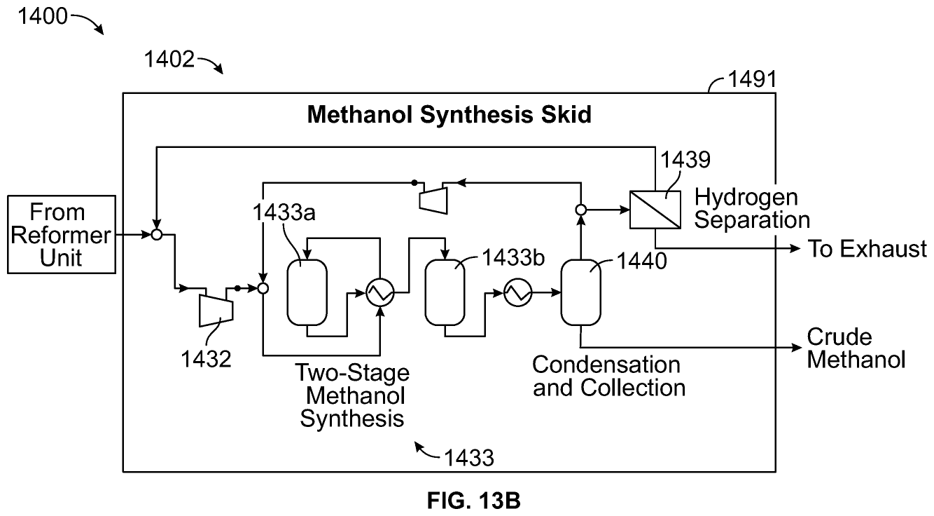

In FIG. 11 there is shown a temperature-entropy (T-S) diagram for the general operation and thermodynamics for the operation of flare gas to methanol systems of the type shown and describe herein, for example in FIGS. 13A and 13B. The overall conversion process from waste gas, e.g., flare gas, to useful product, e.g., methanol, is described using the T-S diagram of FIG. 1. This diagram uses the properties of air, in an air standard approximation of the process. FIG. 1 outlines the general solutions and operation of systems from the point of thermodynamics, temperature and pressure. The diagram shows the starting point of the process at ambient conditions, the high temperature and the pressure conditions for rich, partial oxidation, in the reformer, and for high pressure lower temperature reactions for the synthesis of methanol. Thus, there is shown temperature vs entropy dashed line 201 for 60 bar pressure, dashed line 202 for 30 bar pressure, dashed line 203 for 8 bar pressure, and dashed line 204 for 1 bar pressure. (1 atmosphere is equivalent to 1.013 bar.) The temperature and pressure for the incoming air and the waste gas (e.g., flare gas) is at point 206. The operating conditions for the reformer stage is shown in zone 210 (FIG. 1). Zone 210 has temperatures above at and above 900° C. Zone 210 has two sub-zones, 210a, 210b. Sub-zone 210a is a lower pressure zone (from less than 1 bar to about 25 bar). Sub-zone 210b is a higher-pressure zone (from about 20 bar to about 100 bar), and in particular, a high pressure zone for rich, partial oxidation conditions in the reformer, which are the preferred condictiones for the embodiments of the present inventions. The optimum operation for the synthesis stage is shown in zone 211 for methanal synthesis. The zone 211 is in a temperature of 200-300° C. and a pressure of about 20 bar to 100 bar. A preferred zone for methanol production is 200-300° C. and a pressure of 30-100 bar.

Thus, FIG. 1 is a graphic representation of conditions that may generally be used in a system to provide for the conversion of flare gas to an end product, in this case methanol, and to preferably do so with a neutral (i.e., provides all energy needed to operate the system and process, or positive, provides excess energy) energy balance. The Specific Entropy axis (horizontal axis) is in units of kJ/kg ° C., and describes the entropy per unit mass of air. This type of diagram is a convenient way to show physical processes, such as compression and expansion (nearly vertical lines between pressure levels, and heat exchange (usually at near constant pressure). Ideal compression or expansion is isentropic, meaning no change in entropy, between two pressure levels. Compression with real equipment is non-isentropic as indicated by non-vertical lines. The Temperature axis (vertical axis) is in ° C. and describes the fluid temperature, assumed to have properties similar to air. The relationship between temperature and lines of constant pressure are governed by the physical properties of the fluid. One of the benefits of the T-S diagram is that is allows a visual representation of the physical processes and the relationship between components.

The partial oxidation window 210 defines a region of temperature and pressure where the key partial-oxidation (POX) reactions take place to produce syngas. The region defines the reaction conditions that lead to reaction timescales that are commensurate with the combustion residence in reformers (e.g., a gas turbine, typically 5-50 ms). In general, the POX reaction happens at much higher temperatures than that downstream synthesis (e.g., methanol) reactions, which means that the temperature needs to be reduced in a heat exchanger prior to the methanol reactor.

The methanol synthesis window 211 defines the region of temperature and pressure where the methanol synthesis reactions take place. The region defines the reaction conditions that lead to reasonable equilibrium conversion for this equilibrium-limited reaction. For this exothermic process, lower temperatures are favored for equilibrium conversion but are constrained on the low end by ensuring sufficient catalyst activity. Higher pressures yield higher equilibrium concentrations due to the net decrease in moles in the reaction but require the cost of compression and design for high pressure. While figure specifically shows a methanol synthesis window, it is understood that other possible downstream synthesis reactions, e.g., Fischer-Tropsch synthesis, require similar conditions.

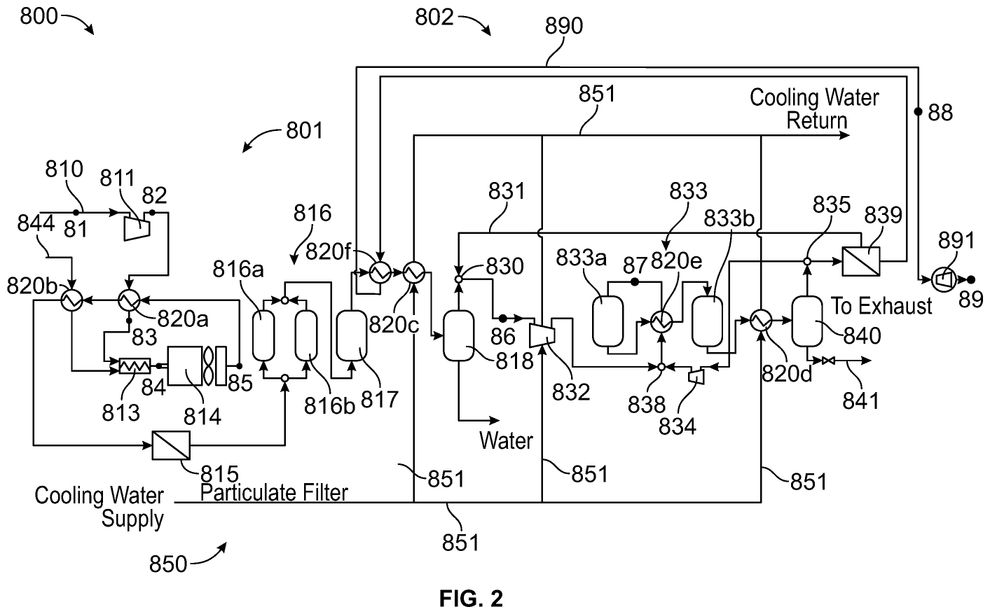

A schematic of a configuration and components of an embodiment of a flare gas to methanol systems is shown in FIG. 2. The system 800 has a reformer stage 801 and a synthesis stage 802. The system 800 has an air intake 810, that feeds air through into a compressor 811, which compresses the air. The compressed air is feed through heat exchanger 820a into a mixer 813. The system has a flare gas intake 884. The flare gas flows through a heat exchanger 820b into the mixer 813. The mixer 813, provides a predetermined mix of air and flare gas, as disclosed and taught in greater detail in this specification, to a reformer 814, which is a reciprocating engine.

The fuel-air mixture that is formed in mixer 813 is preferably rich, more preferably having an overall fuel/air equivalence ratio (0 or ER) greater than 1, greater than 1.5, greater than 2, greater than 3, from about 1.5 to about 4.0, about 1.1 to about 3.5, about 2 to about 4.5, and about 1.1 to about 3, and greater values.

It is understood that oxygen can be added to the air. Water or steam may also be injected into the mixture of air and fuel, or to air or fuel individually. From about 1 to about 20% (molar) water can be injected, from about 10 to about 15% (molar water), from about 5 to about 17% (molar) water, more than 5% (molar) water, more than 10% (molar) water, more than 15% (molar) water, and less than 25% (molar) water, water can be injected. Following oxygen enrichment, the combustion air can have from about 21% (molar) to about 90% (molar) oxygen. “Air-breathing” reformers, and air breathing engines as used herein are understood to also include engines using air modified with the addition of water, oxygen or both.

The reciprocating engine 814 combusts the predetermined mixture of flare gas and air to form syngas. The syngas flows through heat exchangers 820a, 820b and into a filter 815, e.g., a particulate filter.

After passing through the filter 815, the syngas flows to a guard bed reactor assembly 816, optionally having two guard bed reactors 816a, 816b. The guard bed reactor 816 has materials, e.g., catalysts or adsorbents, that remove contaminates and other materials from the syngas that would harm, inhibit or foul later apparatus and processes in the system. For example, the guard bed reactor 816 may contain catalyst or other materials to remove sulfur (e.g., iron sponge, zinc oxide or similar) and halogenated compounds.

After leaving the guard bed reactor 816, the syngas flows to a deoxo reactor 817. The deoxygenation (deoxo) reactor 817 removes excess oxygen from the reprocessed gas (e.g., syngas) by oxidizing combustible compounds in the mixture such as methane, CO, and H₂, where the oxygen is converted to water. Catalyst for the deoxo reaction are platinum, palladium, and other active materials supported on alumina or other catalyst support materials.

The system 800 has a cooling system 850, which uses a cooling fluid, e.g., cooling water, that is flow through cooling lines, e.g., 851. Other means of cooling, for example direct air cooling, are also contemplated.

After leaving the deoxo reactor 817, the syngas flows to heat exchanger 820c. The reprocessed gas (e.g., syngas) then flows from heat exchanger 820f and 820c to a water removal unit 818, e.g., a water knockout drum, demister, dryer, membrane, cyclone, desiccant or similar, where water is removed from the syngas. In general, the syngas upon leaving unit 818 should have less than about 5% water by weight, less than about 2%, less than about 1% and less than about 0.1% water.

After leaving unit 818, the now dry syngas is in the synthesis stage 802. In stage 802 the now dry syngas flows to an assembly 830. Assembly 830 provides for the controlled addition of hydrogen from line 831 into the now dry syngas. In this manner the ratio of the syngas components can be adjusted and controlled to a predetermined ratio. The hydrogen is provided from hydrogen separate 839. The ratio-adjusted dry syngas leaves assembly 830 and flow to compressor 832. Compressor 832 compresses the syngas to an optimum pressure as taught and disclosed in this specification, for use the synthesis unit 833. Preferably, the synthesis unit 833 is a two-stage unit with a first reactor unit 833a and a second reactor unit 833b. Synthesis unit 833 also has heat exchanger 820e.

The synthesis unit 833 converts the ratio-adjusted dry syngas into a value-added product, methanol. The methanol flows into to heat exchanger 820d. The methanol flows to a collection unit 840. The collection unit 840 collects the methanol and flows it through line 841 for sale, holding, or further processing.

Generally, the syngas is compressed to a pressure of about 15 to about 100 bar and preferably 30-50 bar, and about 25 to about 80 bar, at least about 10 bar, at least about 25 bar and at least about 50 bar, and greater and lower pressures. The temperature of the pressurized syngas is adjusted to a temperature of about 150° C. to about 350° C. and preferably 250° C., about 200° C. to about 300° C., about 250° C. to about 375° C., greater than 125° C., greater than 150° C., greater than 200° C., greater than 250° C., greater than 350° C., and less than 400° C., and higher and lower temperatures. The pressure and temperature-controlled syngas is then feed to reactors for transforming the syngas into a more useful, more easily transportable, and economically viable product such as methanol, ethanol, ammonia, dimethyl-ether, F-T liquids, and other fuels or chemicals. In a preferred embodiment methanol is produced using the reaction of syngas to methanol, reactions for hydrogenation of CO, hydrogenation of CO₂, and reverse water-gas shift using actively cooled reactors, such as a heat-exchanged reactor or boiling water reactor, and a copper containing catalyst such as Cu/ZnO/Al₂O₃ or the like.

Generally, and in preferred embodiments, the characteristic length scale of the reactors used in this system are sufficiently small (e.g., micro-channel or mini-channels) that they can be shaped into unconventional shapes and topologies using new 3D printing techniques for metals and other high-temperature materials, thus allowing compact packaging and tight control over reaction conditions. Other strategies for intensification of the downstream synthesis reactions can also be considered, such as selectively removing the product from the reactor in-situ, or in a closely coupled fashion, to shift the equilibrium-limited reaction to higher conversion. This process intensification may minimize the need for large recycle streams or allow the reaction to proceed at milder conditions (e.g., lower pressure) thereby increasing process safety margins.

In general, the ratio of H₂/CO in the syngas produced by the engine can be tailored to the downstream conversion process. For example, for methanol synthesis or Fischer-Tropsch (F-T) synthesis the ideal H₂/CO ratio is 2-3. For ammonia synthesis or for hydrogen production, the maximum possible H₂/CO ratio is desirable and can be enhanced by, for example, steam addition to promote the water-gas shift reaction. For ammonia and hydrogen production, the CO is not required by the downstream synthesis. As such, CO and CO₂ byproducts can be collected, sequestered, stored or utilized for other purposes.

The collection unit 840 also has a line that flows gas separated from the methanol to tee-connector 835, where it is sent to hydrogen separation unit 839, to a recycle loop or both. The recycle loop has compressor 834 and valve 838 to feed the methanol back into the synthesis unit 833. Hydrogen separation can be achieved by via membrane separation or pressure swing absorption (PSA) or the like in the hydrogen separation unit 839.

The remaining gas after hydrogen separation is sent through loop 890 and through heat exchanger 820f to turbine expander 891, where the gas is then sent to exhaust.

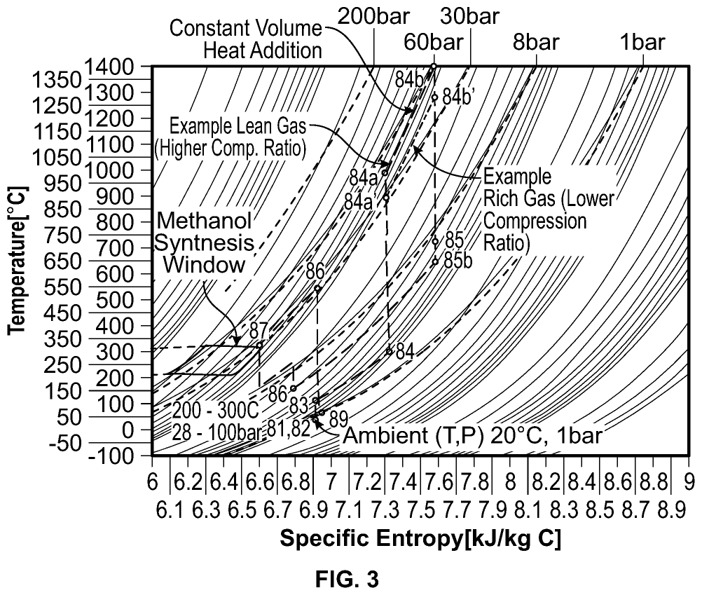

In an embodiment of the system of FIG. 2, the reformer 814 is a spark ignition (otto cycle) reciprocating engine. This system can be preferably operated as set forth in the T-S diagram of FIG. 3. The reference points (numbers—81, 82, 83, 84, 85, 86, 87, 88, 89 in FIG. 2) correspond to process conditions, i.e., state points, at those locations in the system of FIG. 2, and those process conditions are shown by corresponding reference points in FIG. 3. The line from state point 84a′ to 84b′ represents a reduction in compression ratio that occurs in response to a more reactive flare gas fuel. State point 85b relates to the syngas exiting the syngas reformer after the expansion of the turbocharger. The expansion from 85 to 85b occurs within the turbocharger. The starting specific entropy for this process is at points 81, 82 (6.9 kJ/kg ° C.) and the final specific entropy point for this process is 89 (6.95 kJ/kg ° C.). Thus, the difference between the start and final specific entropy is 0.05 kJ/kg ° C.

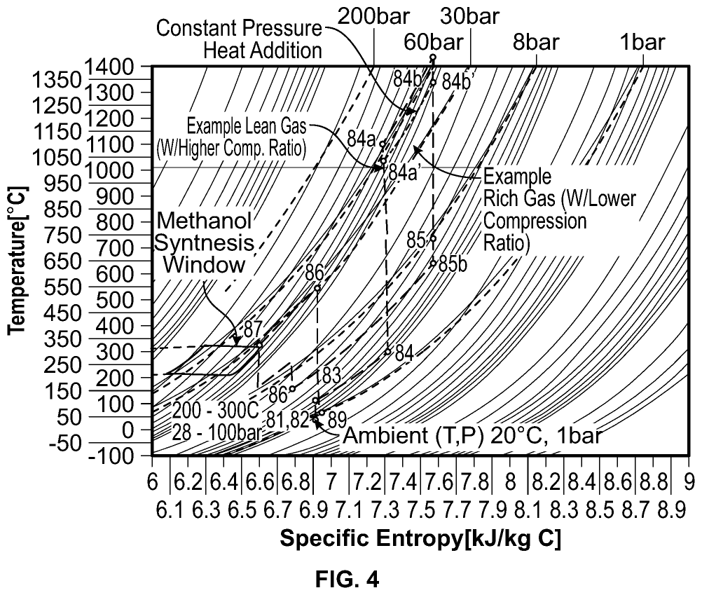

In an embodiment of the system of FIG. 2, the reformer 814 is a compression ignition (diesel cycle) reciprocating engine. This system can be preferably operated as set forth in the T-S diagram of FIG. 4. The reference points (numbers—81, 82, 83, 84, 85, 86, 87, 88, 89 in FIG. 2) correspond to process conditions, i.e., state points, at those locations in the system of FIG. 2, and those process conditions are shown by corresponding reference points in FIG. 4. The line from state point 84a′ to 84b′ represents a reduction in compression ratio that occurs in response to a more reactive flare gas fuel. State point 85b relates to the syngas exiting the syngas reformer after the expansion of the turbocharger. The expansion from 85 to 85b occurs within the turbocharger. The starting specific entropy for this process is at points 81, 82 (6.9 kJ/kg ° C.) and the final specific entropy point for this process is 89 (6.95 kJ/kg ° C.). Thus, the difference between the start and final specific entropy is 0.05 kJ/kg ° C.

In embodiments of these gas-to-liquid systems, including modular system, the system and method utilize a nominally air-breathing engine that is operated under rich conditions to produce syngas. Variation in composition of the fuel results in variation in combustion properties that effect engine operability. In particular, impacted operability parameters include, for example:
Engine misfire—inability to transition from spark discharge to propagating flame, in one or more cylinders of an engine.
Pre-ignition—Premature combustion of the fuel-air mixture in one or more of the cylinders in an engine.
Auto-ignition (knock)—Spontaneous ignition of the fuel-air mixture ahead of the propagating flame.
Low combustion efficiency—high levels of unburned fuel in the exhaust, due to exhaust valve opening before combustion propagation across the cylinder volume is complete, or unburned fuel in crevice volumes and quenching on cold surfaces, or can be related to misfire.

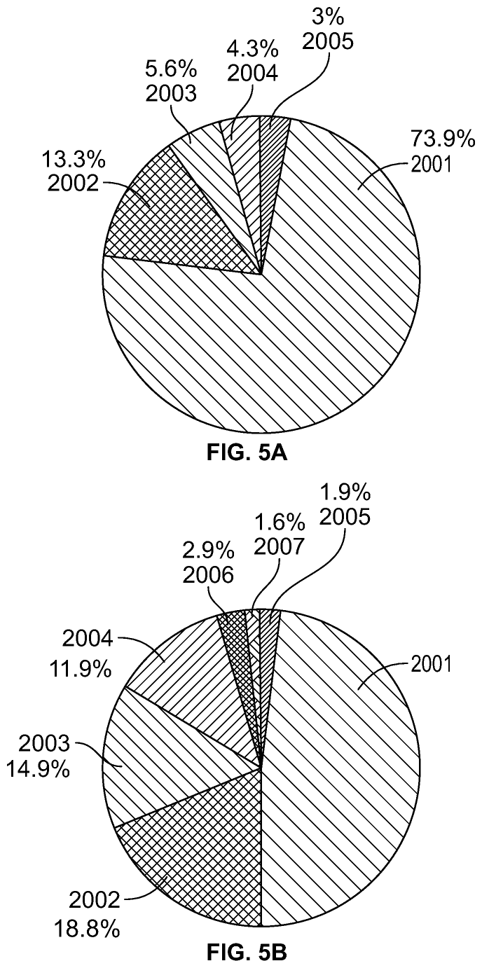

FIGS. 5A and 5B, and Tables 1 and 2, show the range of fuel compositions to be expected for associated gas, flare gas and biogas, respectively. These represent compositions of interest for gas-to-liquids synthesis in small modular systems.

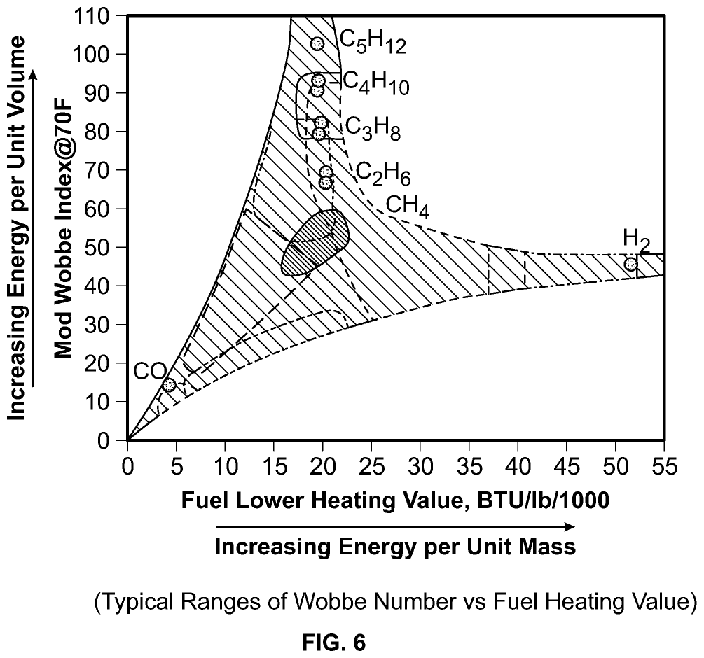

FIGS. 5A and 5B also provide the compositions of flare gas that can occur and are processed by embodiments of the present inventions. FIG. 5A shows a typical composition of a lean flare gas, and FIG. 5B shows a typical composition of a rich flare gas. The lean and rich flare gases can have methane 2001, ethane 2002, propane 2003, butanes 2004, impurities 2005, the rich flare gas can also include pentanes 2006 and hexanes and heavier hydrocarbons 2007. FIG. 6 is a graph showing the Wobbe number vs fuel heating value for various components and variations of flare gases that can occur and are processed by embodiments of the present inventions.

These mixtures and their individual constituents represent wide range of octanes, with the heavier hydrocarbons having lower octane and hence a greater tendency to pre-ignite or auto-ignite. Specific values of octane number, a key measure of mixture reactivity, are shown in Table 3. Estimated values of octane number for the lean and rich gas in FIG. 5 are shown in Table 3.

FIG. 6 shows how the fuel energy per unit volume varies with gas composition. This variation affects the sizing and control of the fuel delivery system.

Examples of the composition of flare gas that any of the reformers of the present systems and methods can process into reprocessed gas, which is then processed by the synthesis units into a value-added product (e.g., methanol, ethanol, ammonia, dimethyl-ether, F-T liquids, and other fuels or chemicals) are set forth in Table 1 and Table 2. The flare gasses can have one or more, and all of the constituents or components in one or more of the various amounts set forth in these tables.

TABLE 1
Examples of flare glass compositions

| Gas Constituent | | % of Constituent | | |
|---|---|---|---|---|
| Name | Formula | Min. | Max | Average |
| Methane | CH₄ | 7.17 | 82.0 | 43.6 |
| Ethane | C₂H₆ | 0.55 | 13.1 | 3.66 |
| Propane | C₃H₈ | 2.04 | 64.2 | 20.3 |
| n-Butane | C₄H₁₀ | 0.199 | 28.3 | 2.78 |
| Isobutane | C₄H₁₀ | 1.33 | 57.6 | 14.3 |
| n-Pentane | C5H12 | 0.008 | 3.39 | 0.266 |
| Isopentane | C5H1; | 0.096 | 4.71 | 0.530 |
| neo-Pentane | CSH₁₂ | 0.000 | 0.342 | 0.017 |
| n-Hexane | C₆H₁₄ | 0.026 | 3.53 | 0.635 |
| Ethylene | C₂H₄ | 0.081 | 3.20 | 1.05 |
| Propylene | C₃H₆ | 0.000 | 42.5 | 2.73 |
| 1-Butene | C₄H₈ | 0.000 | 14.7 | 0.696 |
| Carbon monoxide | CO | 0.000 | 0.932 | 0.186 |
| Carbon dioxide | CO₂ | 0.023 | 2.85 | 0.713 |
| Hydrogen sulfide | H₂S | 0.000 | 3.80 | 0.256 |
| Hydrogen | H₂ | 0.000 | 37.6 | 5.54 |
| Oxygen | O₂ | 0.019 | 5.43 | 0.357 |
| Nitrogen | N₂ | 0.073 | 32.2 | 1.30 |
| Water | H₂O | 0.000 | 14.7 | 1.14 |

TABLE 2
Examples of biogas types of flare gas compositions

| | Source of biogas type flare gas | | | | |
|---|---|---|---|---|---|
| | Municipal | | Agricultural/ | Waste from | |
| Constituent | waste | Wastewater | Animal waste | food industry | Landfill |
| CH₄ (vol %) | 50-60 | 55-77 | 50-75 | 68-75 | 35-70 |
| C0₂ (vol %) | 34-38 | 36-38 | 37-38 | 26 | 15-60 |
| | | 19-33 | 19-33 | | |
| | | 30-45 | 30-50 | | |
| | | 35-45 | 30-40 | | |
| N₂ (vol %) | 0-5 | | <1 | | <1-40 |
| | | <2 | <1-2 | | |
| | | <1 | <3 | | |
| 0₂ (vol %) | 0-1 | <0.5 | <0.5 | | <0.2-5 |
| H₂(vol %) | | | | | 0-5 |
| CO (vol %) | | | | | 0-3 |
| H₂S (ppm) | 70-650 | 63-3,000 | 3-7,000 | 280-<21,500 | 0-20,000 |
| Aromatic | 0-200 | | | | 30-1,900 |
| (mg/m³) | | | | | |
| Ammonia | | | 50-100 mg/m³ | | 5 ppm |
| Halogenated | 100-800 | | | | 1-2,900 |
| compounds | | | | | |
| (mg/m³) | | | | | |
| Benzene | | 0.1-0.3 | 0.7-1.3 | | 0.6-2.3 |
| (mg/m³) | | | | | |
| Toluene | | 2.8-11.8 | 0.2-0.7 | | 1.7-5.1 |
| (mg/m³) | | | | | |
| Siloxanes | | 1.5-15 | <0.4 | | 0.1-4 |
| (ppmv) | | | | | |
| Non- | | | | | 0-0.25 |
| methane | | | | | |
| organics (% | | | | | |
| dry weight) | | | | | |
| Volatile | | | | | 0-0.1 |
| organics (% | | | | | |
| dry weight) | | | | | |

TABLE 3
(Octane numbers of individual constituents (Octane Number
(research octane number = RON))

| Constituent | Octane (research/RON) | Octane (motor/MON) | AKI (R + M)/2 |
|---|---|---|---|
| Methane | 135 | 122 | 128.5 |
| Ethane | 108 | | |
| Propane | 112 | 97 | 104.5 |
| Butane | 93 | 90 | 91.5 |
| Pentane | 61.7 | 61.9 | 61.8 |
| Lean Associated Gas (table 1) | 126 (est) | | |
| Rich Associated Gas (table 1) | 117 (est) | | |

Turning to FIG. 6 it is shown that for gaseous fuels, changes in fuel composition also influence the energy content of the fuel, as quantified by fuel heating value per unit volume (Wobbe number). This figure shows typical ranges of Wobbe number vs fuel heating value for a range of fuel compositions.

Variation in fuel properties sets up a fundamental tension in the design of the system. On one hand, high compression ratio and high inlet air temperature are beneficial for the combustion characteristics to produce syngas with desired H₂/CO ratio (typical range 1.5 to 2.5) with low emission of unburned fuel. On the other hand, high compression ratio and high inlet air temperature can result in pre-ignition, or autoignition of the fuel-air mixture if the fuel becomes more reactive. Conversely, if the fuel becomes less reactive, increased compression ratio or inlet air heating would be beneficial. Thus, setting a specific design point for the engine is not compatible with smooth engine operation with fuel that has variable combustion properties.

In embodiments, the solution to this problem is to modify the engine operating properties while the engine is operating. A combination of modified operating engine parameters including, or example:
compression ratio (effective compression ratio or geometric compression ratio), range 8:1 to 14:1.
inlet manifold air temperature, range of ambient temperature to 300 C.
inlet manifold air pressure, ambient to 5 bar.
spark timing, TDC (top dead center, e.g. zero degrees) to MBT (minimum spark advance for best torque, e.g. 30 degrees typical, 15-45 degree range).
engine speed, 800 rpm to engine max (e.g., 1800 rpm).
combinations and variations of the above.

These modified operating parameters and their range of conditions above can be applied to a two-stroke or four-stroke reciprocating engine

To detect if the engine is operating correctly in an autonomous system, a set of sensors can be used. These sensors can include, for example:
Knock detection (vibration-based sensors) mounted to the block or head.
Lambda sensor (sensor that infers air to fuel ratio from exhaust gas composition, typically mounted downstream of exhaust valves).
Exhaust temperature (typically thermistor or thermocouple) mounted downstream of the exhaust valves.
Intake manifold temperature and pressure.
Fuel sensors including mass flow, dew point temperature, and heating value (e.g., calorimeter).
Combinations and variations of the above.

The present inventions, including the embodiments of the Examples, can use and reprocess flare gases falling within any of the ranges of compositions and components set forth in Table 1, Table 2 and combinations of the compositions and ranges in these tables, as well as, other compositions and ranges of components.

In an embodiment, the present inventions generally relate to systems, devices and methods to convert otherwise uneconomic hydrocarbon-based fuel, e.g., flare gas to a to value-added, easily transported products (such as, methanol, ethanol, ammonia, dimethyl-ether, F-T liquids, and other fuels or chemicals, and combination and variations of these). These embodiments in general have a flare gas (i.e., fuel) conditioning system, an air-breathing reciprocating engine, and a conditioning assembly that conditions the syngas for storage, shipping, later processing and combinations and variations of these. The flare gas is conditioned to remove impurities and materials that could be detrimental to later processing steps. The flare gas (e.g., fuel gas for the system) is then mixed with air and ignited in an engine.

In an embodiment, the fuel-air mixture is rich, preferably having an overall fuel/air equivalence ratio (0 or ER) greater than 1, greater than 1.5, greater than 2, greater than 3, from about 1.5 to about 4.0, about 1.1 to about 3.5, about 2 to about 4.5, and about 1.1 to about 3, and greater values.

In an embodiment, oxygen can be added to the air. Water or steam may also be injected into the mixture of air and fuel, or to air or fuel individually. From about 1 to about 20% (molar) water can be injected, from about 10 to about 15% (molar water), from about 5 to about 17% (molar) water, more than 5% (molar) water, more than 10% (molar) water, more than 15% (molar) water, and less than 25% (molar) water, water can be injected. Following oxygen enrichment, the combustion air can have from about 21% to about 90% oxygen. “Air-breathing” engines, and similar terms, as used herein, are understood to also include engines using air modified with the addition of water or oxygen. Thus, “air” added to these engines in embodiments of the present systems, can also include oxygen enriched and steam or water enriched air and systems.

The engine, e.g., the air breathing reciprocating engine, produces syngas, (as well as heat and mechanical energy, which can be used to power and operate other components of the systems and preferably the entire process), which is then filtered and heat from the syngas is recovered by a heat exchanger.

The overall (general) reaction for rich fuel/air mixture to syngas is given by the equation:

ϕCH₄+2[O₂+3.76 N₂]->aCO+bH₂+cCO₂+dH₂O+7.52 N₂

Where stoichiometric coefficients a, b, c and d are determined by the chemical kinetics, conservation of atomic species, and the reaction conditions.

In addition to syngas minor constituents in the gas exiting the gas engine include water vapor, CO₂, and various unburned hydrocarbons.

Generally, the syngas is compressed to a pressure of about 15 to about 100 bar and preferably 30-50 bar, and about 25 to about 80 bar, at least about 10 bar, at least about 25 bar and at least about 50 bar, and greater and lower pressures. The temperature of the pressurized syngas is adjusted to a temperature of about 150 to about 350° C. and preferably 250° C., about 200 to about 300° C., about 250 to about 375° C., greater than 125° C., greater than 150° C., greater than 200° C., greater than 250° C., greater than 350° C., and less than 400° C., and higher and lower temperatures. The pressure and temperature-controlled syngas is then feed to reactors for transforming the syngas into a more useful, more easily transportable, and economically viable product such as methanol, ethanol, ammonia, dimethyl-ether, F-T liquids, and other fuels or chemicals. These reactions and reactors are well known in the art and any commercially available reactor to carry out these reactions can be employed. In a preferred embodiment methanol is produced using the reaction of syngas to methanol, reactions for hydrogenation of CO, hydrogenation of CO₂, and reverse water-gas shift using actively cooled reactors, such as a heat-exchanged reactor or boiling water reactor, and a copper containing catalyst such as Cu/ZnO/Al₂O₃ or the like. In general embodiment can use the following reactions:

CO+2H₂→CH₃OH (CO hydrogenation)

CO₂+3H₂→CH₃OH+H₂O (CO₂ hydrogenation)

CO+H₂O→CO₂+H₂ (water-gas shift)

Generally, and in preferred embodiments, the characteristic length scale of the reactors used in this system are sufficiently small (e.g., micro-channel or mini-channels) that they can be shaped into unconventional shapes and topologies using new 3D printing techniques for metals and other high-temperature materials, thus allowing compact packaging and tight control over reaction conditions. Other strategies for intensification of the downstream synthesis reactions can also be considered, such as selectively removing the product from the reactor in-situ, or in a closely coupled fashion, to shift the equilibrium-limited reaction to higher conversion. This process intensification may minimize the need for large recycle streams or allow the reaction to proceed at milder conditions (e.g., lower pressure) thereby increasing process safety margins and providing other advantages.

Typically, in reacting the syngas to form the higher value product, unreacted H₂ is also produced. The H₂ can be collected and sold, or used to power a second generator to produce additional electric power.

The ratio of H₂/CO in the syngas produced by the engine can be tailored to the downstream conversion process. For example, for methanol synthesis or Fischer-Tropsch (F-T) synthesis the ideal H₂/CO ratio is 2-3. For ammonia synthesis or for hydrogen production, the maximum possible H₂/CO ratio is desirable and can be enhanced by, for example, steam addition to promote the water-gas shift reaction. For ammonia and hydrogen production, the CO is not required by the downstream synthesis. As such, CO and CO₂ byproducts can be collected, sequestered, stored or utilized for other purposes.

In an embodiment the system is a mobile system that is contained in a shipping container frame that would fit on a single semi-truck trailer, length about 40 feet to about 60 feet, width about 6 feet to about 10 feet, and height of about 7 feet to about 15 feet. The system may also be in one, two or more separate shipping containers or open skid frames, which are then assembled into a flare gas recovery system at the location of the flare gas, e.g., an oil field, an oil well, an off-shore platform, or a floating production storage and offloading (FPSO) vessel.

In an embodiment the mobile systems are sized and configure to processes from flare gas flows of from about 50,000 scfd (standard cubic feet per day) to 30,000,000 scfd, from about 400,000 scfd to 30,000,000 scfd, from about 500,000 scfd to about 20,000,000 scfd, from about 600,000 scfd to about 15,000,000 scfd, from about 700,000 scfd to about 10,000,000 scfd, from about 1,000,000 scfd to about 25,000,000 scfd, greater than about 250,000 scfd, greater than about 500,000 scfd, greater than about 750,000 scfd, less than 10,000,000 scfd, less than 5,000,000 scfd, and less than 1,000,000 scfd, and larger and smaller flows. It further is contemplated that one, two or more of these mobile systems can be placed at a location associated with flare gas, such as an oil field, having a large number of wells, and the flare gas can be piped from several wells to these mobile systems. Thus, providing complete coverage, i.e., capture and recycling of all of the flare gas produced from the oil field.

Embodiments of these systems process provide low carbon reprocessing of flare gas, and are preferably carbon neutral-to-negative and energy positive. In this manner embodiments of the present systems and processes capture the flare gas and convert the flare gas to an end product (e.g., methanol, ethanol, etc.) while generating sufficient energy (mechanical, electrical and both) to operate the system. In making the end product, the system is essentially carbon neutral-to-negative due to the combination of two effects: (1) Instead of being released as CO₂ and methane slippage, carbon from the flare gas is sequestered in the methanol thus displacing the flare gas emissions, and (2) instead of producing methanol by conventional means from natural gas or coal, that methanol is displaced by methanol produced from flare gas. Thus, in embodiments the system and its process produce from about −40 kg CO₂e to −130 kg CO₂e (net carbon-negative), per kg of downstream product (in this case, liquid methanol), and more preferably produce, release and both, zero CO₂.

More preferably, these units also produce sufficient energy to have excess energy available to operate other devices or for other purposes, e.g., oil field operations, computers having high electrical needs for processing complex algorithms, charging electric vehicles, battery storage, etc.

In embodiments, these systems also have monitor and metering devices to monitor and control and memory devices to record the amount of flare gas processed, the amount of product produced and the amount, if any, of CO₂ produced. This information will be recorded in a secure manner for use or transmission to support carbon capture credits, or other regulatory or private equity or exchange transaction relating to CO₂. These monitor, metering and control devices, systems and methods find applicability generally in embodiments of the present gas-to-liquid systems, including systems of the type described and taught in US patent publication no. 2022/0388930. In particular, these monitor, metering and control devices, systems and methods find applicability rich operating condition engines used as reformers in these gas-to-liquid systems.

More preferably the control system (and sub-systems if any) operate the entire mobile system and processes. The mobile systems are configured for real time or near real time monitoring and control from a remote location, or on site.

### EXAMPLES

The following examples are provided to illustrate various embodiments of the present flare gas conversion process and systems, systems and methods for rich operation of air breathing engines. In particular, embodiments of these systems using a rich operating condition air breathing engines as reformers in these processes and systems. These examples are for illustrative purposes, may be prophetic, and should not be viewed as, and do not otherwise limit the scope of the present inventions.

### Example 1

In an embodiment of the present inventions have a rich-burn reciprocating engine and a synthesis reactor. Unlike a traditional reciprocating engine, the engine runs at rich conditions, up to equivalence ratio of 2.5, so the fuel experiences rich partial oxidation (POX). Additional components include the fuel conditioning system, heat exchangers, compressors, and turbines. The fuel conditioning system separates liquids from gases in the feed stream and removes compounds that can damage the reciprocating engine or synthesis reactor. The heat exchangers and compressors take the syngas mixture at the exit of the reciprocating engine and adjust the temperature and pressure to deliver the target conditions for the synthesis reactor. Within the synthesis sub-system is an optional H₂ recycle loop. The gas at the exit of the synthesis reactor is heated in a recuperating (e.g., counter-flow) heat exchanger to an elevated temperature and then expanded to ambient conditions. It is understood that the engine could have either fixed or variable compression ratio.

### Example 2

In this embodiment it is preferable that in configuring and operating a syngas engine for achieving preferred engine operation under conditions sufficiently rich to produce a syngas with the desired H₂/CO ratio near 2. Even if acceptable operability is achieved with one fixed fuel composition, changes to the fuel composition, which will arise during operation in the field, for example at an oil well, will change the combustion properties and lead to poor engine operation. Thus, the engine has sensors and control systems that detect changes in the combustion properties of the fuel and adapt its parameters to achieve desired engine operation. An engine with a combination of sensing and variable compression ratio can overcome these challenges. A variable compression ratio engine adjusts the compression ratio of an internal combustion engine while the engine is in operation. Variable compression engines allow the volume above the piston at top dead center to be changed. It is understood that the engine could have either fixed or variable compression ratio.

### Example 3

An embodiment of a variable compression ratio engine is through the use of variable valve timing, such as cam phasers. Twin Independent Variable Camshaft Timing (Ti-VCT) is the name given by Ford to engines with the ability to advance or retard the timing of both the intake and exhaust camshafts independently, unlike the original versions of VCT, which only operated on a single camshaft. This allows for improved power and torque, particularly at lower engine RPM, as well as improved fuel economy and reduced emissions

A “cam phaser” is an adjustable camshaft sprocket, gear, or pulley that can be turned by means of a computer-controlled servo. Rather than operating with a fixed amount of advance or retard, the computer can advance or retard the cam or cams continuously. An embodiment of this application is to enhance drivability at light load and low engine speed (by reducing overlap of the intake and exhaust events to minimize residual dilution), and generate more power at high engine speed (by retarding the intake valve event to increase volumetric efficiency).

For rich combustion operation to produce syngas, when the fuel composition is richer (greater fraction of low-octane constituents) the purpose of retarding the timing of the intake valve event is to retard valve closing sufficiently to shorten the effective compression stroke and thus reduce the effective compression ratio.

When the fuel composition is leaner (greater fraction of high-octane constituents) the purpose of advancing the timing of the intake valves is to advance intake valve opening sufficiently to extend the effective compression strokes and thus increase the effective compression ratio. Operating at a higher effective compression ratio increases pressure and temperature in the combustion chamber and thus extends the rich combustion limit with lean gas.

An VVT/cam phaser engine that allows, among other things, the effective compression ratio to be varied according the properties of the incoming fuel for rich combustion to produce syngas is novel.

A VVT/cam phaser engine with sensors to detect the in-cylinder combustion behavior under rich conditions and automatically adjust the compression.

This approach can be applied to a two-stroke or four-stroke reciprocating engine.

### Example 4

A system and process to convert otherwise uneconomic hydrocarbon-based fuel such as flare gas to value-added, easily transported products (such as methanol, ethanol, ammonia, dimethyl-ether, F-T liquids, and other fuels or chemicals) using an autonomous, modular system comprising the following elements: (1) a fuel conditioning system to meet requirements of downstream components; (2) an air-breathing gas engine, modified to operate a rich, partial-oxidation reformer, to produce a syngas mixture with a H₂/CO ratio suitable for synthesis of liquids; (3) a combination of integrated heat exchangers, compression system components, and heat exchangers to prepare the syngas for the downstream synthesis reactors; (4) a downstream synthesis reactor system to produce useful liquid hydrocarbon products; and, (5) a hydrogen recycle loop to improve overall system process performance.

### Example 5

An embodiment of a variable compression ratio engine is through an opposed-piston free-piston linear internal combustion engine. A free-piston engine is a linear, ‘crankless’ internal combustion engine. The power delivered by the engine is not delivered via a crankshaft, but instead through exhaust gases driving a turbine or a linear motor/generator directly coupled to the pistons to produce electric power.

### Example 6

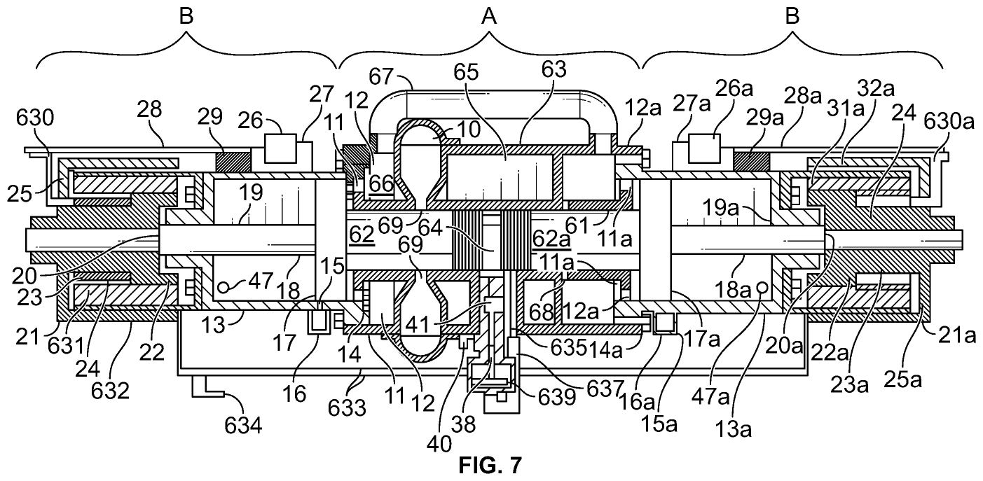

Turning to FIG. 7, there is shown an embodiment on an engine for production of syngas from compression-ignition of rich fuel-air mixtures is preferred due to simplicity (lower part count) and better performance (high compression ratio yielding faster burn times). This engine reformer can be used in embodiments of the present systems, including the examples. An example architecture is the opposed-piston free-piston linear internal combustion engine with integrated linear motor/generator, such as that produced by MainSpring Energy. U.S. Pat. No. 2,362,151 discloses a basic engine configuration for modification in accordance with the teachings of the present specification, the entire disclosure of which is incorporated herein by reference.

Thus, turning to FIG. 7, the a free piston engine “A” is connected to two single phase generators “B” and “B”, which can be operated by the engine. When used as a reformer the generators may not be present, or can be used to power components in the system.

The free piston engine A has a cylinder 61 in which the pistons 62-62a reciprocate and which is surrounded by a second cylinder 63 having the annular water chamber 65 therein encompassing the combustion chamber 64 of the engine. Annular air chambers 66 are formed in the end portions of cylinder 63 as shown and are connected by a passage 67 whereby the air pressure in the two chambers is equalized. Intake passages 68 lead from chamber 66a to the interior of cylinder 61, and discharge passages 69 lead from the opposite end portion of the cylinder 61 to discharge into manifold 10.

Inasmuch as the two ends of the device are duplicates one end only will be described in detail and similar parts on the other end will be indicated by similar characters followed by the character “a”.

Through the outer end of chamber 66 are formed passages 11 fitted with inwardly opening check valves 12, the said passages leading to an annular cylinder 13 axially disposed relative to cylinder 61 and somewhat larger In diameter than said cylinder- and mounted end wise thereon as at 14. This cylinder 13 is provided with an air intake passage at 15 fitted with an inwardly operating check valve as at 18 and disposed adjacent the inner end of said cylinder.

The piston 12 has an enlarged head 17 thereon to reciprocate in chamber 13, and a stem 18 projects axially outwardly from said head and through the bearing 19 in the outer end of the chamber 13 and has a shoulder 20 formed therein as shown, exteriorly of chamber 13 to form a seat for the magnet 21.

The magnet 21 is a field magnet, and in the present instance comprises a part 22, circular in form, seated on the shoulder 20, a second member 24 of smaller diameter seated on the member 22, and a winding of wire on the second member as indicated at 23 and grounded to said second part. This second member 24 is also provided with a flange 25 extending outwardly from its outer end at right angles to its axis, and then turned backwardly in parallel relation with the axis and with a diameter slightly greater than the chamber 13 to encompass the magnet parts 22 and 24 as shown. The winding 23 is energized by means of a battery at 26 grounded to the engine at 21 and connected to a bar 28 mounted upon the engine at 29 and extending forwardly thereof as indicated, in parallel relation with its axis. A shoe 630 slidably engages the bar 23 and is in fixed contact with the coil 23 so that the magnet is energized at all times regardless of its position with relation to the fixed end of the device.

The armature comprises a coil of wire as 631 within a supporting cylinder 632 mounted upon the outer end of chamber I! to encompass the magnet parts 22 and 24. Wires as 633 connect the armatures 631 and 631a, and, electricity is taken off of these wires as at 34.

When the device is in operation the outward movement or the piston heads 17-17a draw air into the chambers 13-13a through valves 16-16a, and on their inward movement push the air through valves 12 into chamber 66-66a. The air in chamber 68a is sufficiently compressed to flow forcibly into the cylinder 61 when the piston 62a uncovers the passages 68. The exhaust passages 69 are uncovered at substantially the same time as the passages 68 so that the air entering the cylinder 61 at 68 will scavenge the same and carry out all of the burnt gases at 69 leaving the cylinder filled with fresh air.

But in the movement of pistons 12-12a just described the piston heads 17-17a compress the air entrapped in the chamber 13-13a, which form cushions which forcibly drive the said pistons back in cylinder 61 compressing the air therein. As the pistons approach each other the compressed air trapped between them, or at least a small portion thereof, is discharged through passage 635 and pipe 637 to actuate a plunger 638 in injector 639 in which the fuel oil is admitted at 49 and discharged through valve 41 into combustion chamber 64. These parts are proportioned and arranged to form a combustible mixture at the moment when the pistons 62-62a approach each other most closely, the resulting explosion diving the pistons outwardly again to repeat the cycle. The valves at 47-47a are inserted in chambers 13-13a to permit the drawing of air into said chambers to compensate for such air as may leak out of the same past the heads 17-17a or paste bearings 19-19a.

In an engine of this kind the pistons 62-62a are reciprocated at high speed, upwards of some ten thousand times a minute, and the magnets 21-21a are, or course, reciprocated at the same high speed. In this manner the mechanical energy of the engine is converted into electrical energy, since the rapid reciprocation of the magnetic fields about the magnets 21-21a through the induction coils 631-631a will rapidly alter the number of lines or force passing through the coils.

This engine is modified with digital electronic controls (sensor and control system) to achieve a practical and high efficiency engine for small-scale power generation. This approach can be applied to a two-stroke or four-stroke reciprocating engine, although a linear engine with fixed ports in the side walls is generally operated as a two-stroke. Thus, this linear engine operating under rich conditions can be a reformer in any of the embodiments of the present gas-to-liquid systems, including the Examples, as well as, systems of the type described and taught in US patent publication no. 2022/0388930 to produce syngas. Preferably this linear engine reformer is a free-piston configuration with an electronically-control linear motor/generator that allows the compression ratio to be varied according the properties of the incoming fuel. This linear engine reformer may also have a free-piston configuration with sensors to detect the in-cylinder combustion behavior under rich conditions and automatically adjust the compression ratio.

### Example 7

An embodiment of a variable compression ratio engine is through a crankshaft-driven opposed-piston engine utilizing a variable phaser on the crankshafts.

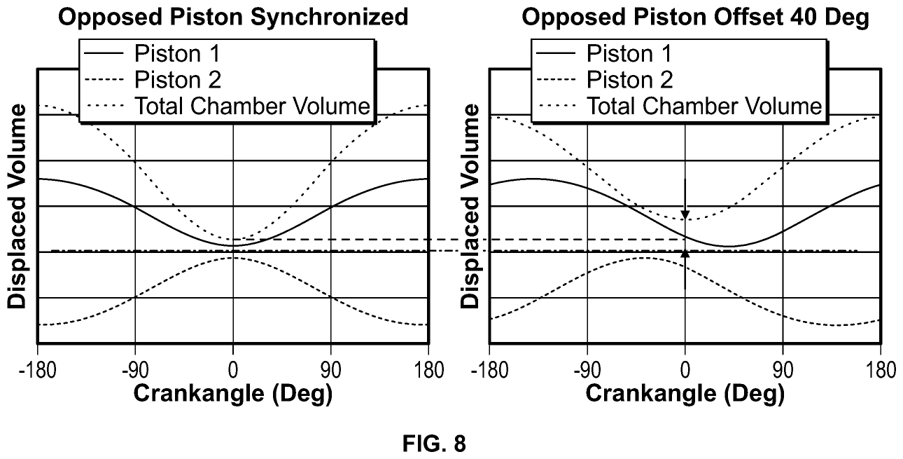

Combustion chamber volume in such an engine is dictated by the relative positions of the pistons. Offsetting motion of one piston to the other increases minimum volume, thereby reducing compression ratio. Turning to FIG. 8 there is shown a comparison of displaced volume when the opposed pistons are synchronized (left) vs. offset by 40 degrees (right). The compression ratio is higher when the pistons are synchronized and reduces when the pistons are offset.

An example of an opposed-piston linear engine with crank shafts is an engine developed by Achates Engines.

The application of this concept to an opposed piston engine with a variable phaser on the crankshafts to run rich with variable fuel to produce synthetic gas is novel.

This approach can be applied to a two-stroke or four-stroke reciprocating engine, although a linear engine with fixed ports in the side walls is generally operated as a two-stroke.

### Example 8

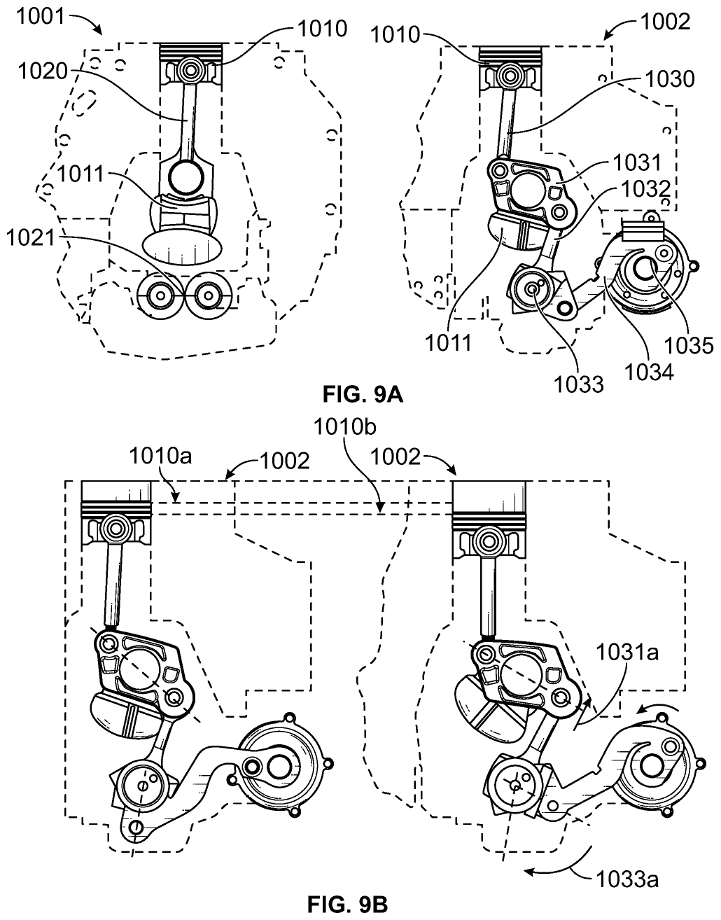

Turning to FIGS. 9A and 9B there is shown an embodiment of a variable compression ratio engine that can be used as a reformer in embodiments of the present systems, including the Examples. The variable compression ration engine, 1002 can be one such as the Nissan VC-turbo engine, that uses a multi-link system in place of a traditional connecting rod to rotate the crankshaft, and an actuator motor changes the multi-link system endpoint in order to vary the pistons' reach to transform the compression ratio.

FIG. 9A is a cutaway view of a conventional engine 1001 compared to a partial cutaway view of a variable compression engine 1002. The piston 1010 are the crank 1011 are the same. The conventional engine 1001 has a connection rod 1020, and a 2^{nd} balancer 1021. The variable compression engine 1002 has a U-link 1030, an L-link 1031, a C-link 1032, a control shaft 1033, an A-link 1034 and an actuator Motor 1035.

The components of the variable compression engine 1002 make it possible to vary the compression ratio continuously as needed within the range of about 8:1 (for high load) to about 14:1 (for low load). For an automobile engine made by Nissan, the optimal compression ratio can be continuously set to match the operation of the accelerator pedal by the driver. A schematic of this linkage is shown on FIGS. 9A and 9B. The effects of this linkage on piston height is shown on FIG. 9B. This approach can be applied to a two-stroke or four-stroke reciprocating engine, although an engine as described here is preferably operated as a four-stroke. Thus, using the variable compression engine as a reformer, the optimal compression ratio for producing syngas can be continuously set to accommodate combustion properties from variation in the flare gas with variable compression ratio. In this manner, in embodiments, an engine with a linkage to rotate the crankshafts to vary the compression ratio to run rich with variable flare gas compositions is utilized to produce synthetic gas.

Thus, and for illustration, turning to FIG. 9B, the relative adjustments for the variable compression reciprocating engine reformer 1002 are shown. Piston height 1010a is for 14:1 compression ratio. Piston height 1010b is for 8:1 compression ratio. The adjustment of the linkages are shown by arrows 1031a and 1033a.

This approach can be applied to a two-stroke or four-stroke reciprocating engine, although an engine as described here is generally operated as a four-stroke.

In a similar way to the description above, the optimal compression ratio for producing syngas can be continuously set to accommodate combustion properties from fuel with variable compression ratio.

The application of this concept to an engine with a linkage to rotate the crankshafts to vary the compression ratio to run rich with variable fuel to produce synthetic gas.

### Example 9

This invention will be used to take uneconomic hydrocarbon-based fuels at a well-head and remote locations that are primarily gaseous hydrocarbons and convert them to a more valuable easily condensable or liquid compounds, such as methanol. One source of source fuel could be associated gas or flare gas, which is produced as a byproduct at oil wells. Another source could be biogas from landfill or anaerobic digesters.

A small-scale plant, targeting 3,000,000 scfd (standard cubic feet per day) of inlet gas. The size of such a plant could vary from 50,000 scfd to 15,000,000 scfd. The plant is incorporated into one or more modular, interconnected skids or containers that are built at a central fabricator shop location and then installed at a field location. A small number of modules comprise the system and when connected at site they form an integrated system. The modular nature of the assembly enables application to remote locations under a range of inlet gas feed volumes, with a minimum of field labor. The modular nature further improves flexibility to deploy or redeploy these assets, reduces initial capital outlay and project financial risks, allows matching of the process throughput to the flare gas supply, and reduces time-to-market by allowing module fabrication and site preparation to occur in parallel.

### Example 10

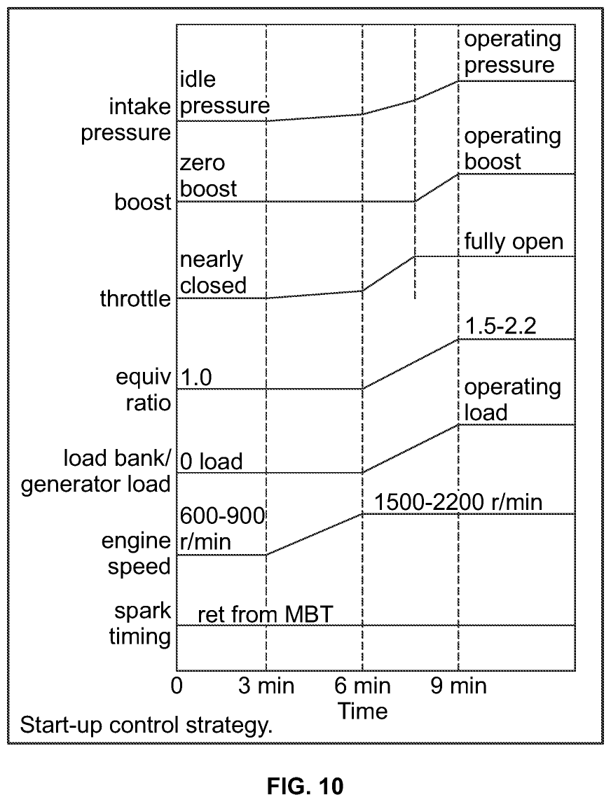

Turning to FIG. 10 there is provided a flow chart showing a method of start-up control operation, provided by an embodiment of a control system.

Engine start will be at nearly-closed throttle with a stoichiometric air/fuel ratio as is standard in most spark ignited engines. Stoichiometry is established in the calibration (open loop control) and fine-tuned using feedback from the Lambda sensor to an equivalence ratio of 1.0. Spark timing is typically retarded significantly from MBT and will remain retarded from MBT to provide a rapidly-varied means of engine speed/load control (as discussed above).

After roughly three minutes of operation at idle speed and load, the throttle will open until the desired operating engine speed is attained.

As load is applied slowly (through the generator and/or load bank), speed is maintained by opening the throttle further.

Once the throttle is open fully, speed is maintained while further increasing load by increasing intake boost (increasing intake pressure).

Stable full-load, full-rich operation is achieved once the target boost level is reached.

### Example 11

In an embodiment the life and operability of a feedback-control-sensor is protected and extended by only exposing and utilizing the sensor intermittently.

FIG. 11 shows a cross section schematic of an intermittent bypass system 1100. The system 1100 has a line or conduit 1101 that contains an exhaust gas flow. The system 1100 has a line or conduit 1102 that provides for air, e.g., ambient air, flow. In operation of system 1100 the exhaust sensor 1104, e.g., a Lambda sensor, is only exposed to exhaust gas when the two bypass valves 1103a and 1103b are actuated, and thus direct exhaust gasses into line 1102 past sensor 1104 and then back to line 1101. Otherwise, the sensor d1104 is exposed to ambient air.

Bypass valves are actuated when engine speed fluctuations require control system responses (as outlined above) exceeding pre-determined response limits. In such cases the bypass valves are actuated, equivalence ratio is measured, and fuel flow is modified as necessary to restore the target equivalence ratio.

After the equivalence ratio is restored and engine operation is stable, the bypass valves close restoring exposure of the sensor to ambient air. Sensor life when exposed to ambient air is significantly greater than when exposed to exhaust gas.

Optionally the upstream bypass valve 1103a of FIG. 11 may also be partially opened allowing both exhaust gas and a diluent (ambient air or a substantially oxygen-free inert gas such as nitrogen) to mix and pass over the Lambda sensor. The downstream bypass valve may be either open, returning the diluted syngas to the main exhaust stream, or closed, directing the diluted exhaust gas to the “air” line, or partially open, directing a fraction of flow to both places. The gas flow needed for the Lambda sensor is substantially less than the gas flow in the exhaust line, so any loss of gas through the slipstream measurement loop would be minor.

Diluting the raw exhaust gas with the diluent reduces the measured lambda value, which has two potential advantages. First, the effective measurement range of the sensor can be extended to higher lambda values. And second, it may extend the life of the sensor by reducing the exposure of the sensor to high concentrations of partial-oxidation products.

Correcting the measured lambda value in the diluted sample gas to obtain the true lambda value in the raw exhaust gas can be accomplished by applying a correction factor related to the dilution ratio. The dilution ratio is defined as the ratio of the mass flow of diluted sample to the Lambda sensor divided by the mass flow of raw exhaust from the bypass. The dilution ratio may be determined from measurement of the mass flows using a flow meter, such an orifice plate, thermal flowmeter, or the like.

Or, in a preferred embodiment, the dilution ratio is determined without a separate mass flow measurement by comparing the measured lambda values with the bypass values fully opened and partially opened during a period of stable engine operation. In this way, the dilution ratio may be inferred from the difference in Lambda measurements in those two modes. The dilution-ratio based correction factor may be periodically checked and updated during engine operation by switching the bypass valve from the partially opened to the fully open (actuated) position and measuring lambda directly in the raw exhaust. In this embodiment, other measurements that would affect exhaust mass flow to the bypass measurement loop, such as exhaust backpressure, may also optionally be included in the correction factor.

### Example 12

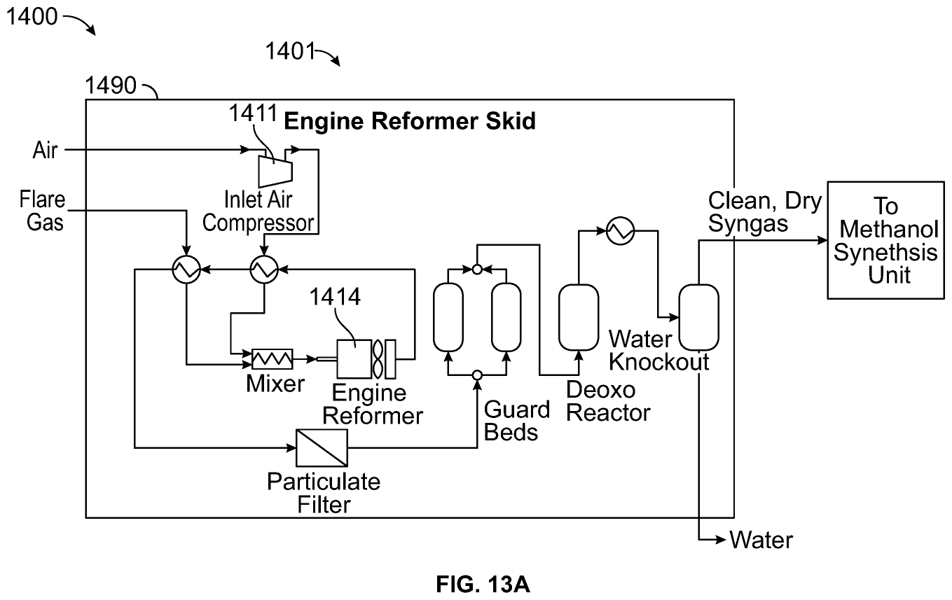

Operational attributes of a spark ignition internal combustion engine running extremely rich to produce synthesis gas differ significantly from conventional spark ignition engine attributes, as is shown in the diagram of FIG. 12.

In FIG. 12, there is shown a Venn diagram 100, showing examples of some of the improvements embodiments of the present inventions provide in flare gas recovery applications over prior operating conditions of spark ignition internal combustion engines. Thus, it is seen that typically operational attributes of a spark ignition internal combustion engine running rich, in accordance with embodiments of the present inventions, to produce synthesis gas (e.g., 102) differ significantly from conventional spark ignition engine attributes (e.g., 101). Conventional attributes such near complete oxidation, CO emissions minimization and power are replaced by partial fuel oxidation, H₂ and H₂/CO emissions maximization and gas throughput. The Venn diagram further shows the additional features and benefits of embodiments of the present inventions relating to operability and commercial embodiments (e.g., 103).

In embodiments of the present rich operating engines, systems and methods, conventional attributes such as near-complete fuel oxidation, CO emissions minimization and power are replaced, for example, by partial fuel oxidation, H₂ and H₂/CO emissions maximization and gas throughput.

Engine control and operability is challenged by the rich fuel-air mixtures required to produce syngas with needed H₂/CO ratio. Conventional engine control systems are designed for stochiometric or lean burn engines. These strategies are not appropriate for rich burn operation (meaning equivalence ratio greater than 1.5).

Embodiments of the solution involves, among other things, feed-forward and feedback approaches, physics-based engine model, novel use of a lambda sensor (O₂-based sensor), sensors with intermittent contact with the gas stream.

### Example 13

A closed-loop feedback charge mixture control to internal combustion engines running extremely rich, e.g., ER from 1.5 to 5, to produce synthesis gas (carbon monoxide and hydrogen).

### Example 14

A control system for controlling the operation of a reciprocating engine at an ER of 1 and greater.

### Example 15

A control system controlling the operation of the reciprocating engine in a smooth and efficient manner at an ER of 2 and greater. This control system and engine so operating as a component in a gas-to-liquid system.

### Example 16

A spark ignition engine operating near a fuel-to-air equivalence ratio of 1.2 and greater for the conversion of flare gas into synthesis gas (syngas) having a modified lambda sensor and control system to maintain in a smooth and efficient manner those rich operating conditions.

### Example 17

A rich burning spark ignition engine having a closed-loop mixture control under fuel rich operating conditions including: sensor means; periodic sensor exposure to sampling stream; sensor calibration; signal enhancements/offsets; and sensor lifecycle monitoring.

### Example 18

Any of the presently disclosed rich operation engines, systems and methods, including the above Examples, can be utilized with the reformer in gas-to-liquid systems, including the present systems, systems of the type described and taught in US patent publication no. 2022/0388930, and for example the system and process of FIGS. 13A and 13B.

Turning to FIG. 13B there is shown a modular reformer system and process that is a portion of a gas-to-liquid system 1400. This system 1400 has a reformer stage 1401, that can be placed on a transport system 1490 (e.g. skid, truck bed, rail car, ship deck, barge, drilling platform, drill ship, container, or other platform, base or container), that can be readily moved by rail, air, truck or ship. The stage 1401 has a compressor 1411 and an engine reformer 1414, as well as other components as labeled on the drawing as taught and disclosed in this specification. It being understood that any of the engine reformers of the present systems and Examples could be used in the stage 1401. The stage 1401 provides clean syngas.

Turning to FIG. 13B there is shown a modular methanol synthesis system and process that is a portion of a gas-to-liquid system 1400. This system 1400, has a synthesis stage 1402, that can be placed on a transport system 1491 (e.g., skid, truck bed, rail car, ship deck, barge, drilling platform, drill ship, container, or other platform, base or container), that can be readily moved by rail, air, truck or ship. This stage 1402 is configured to receive clean, syngas. This stage 1402 can be used with the reformer stage 1401 of Example 18, as well as with other reformer stages as taught and disclosed in this specification, including the Examples. The stage 1402 produces an end product, e.g., methanol, from syngas.

The stage 1402 has a synthesis unit 1433, which is a two-stage unit with a first reactor unit 1433a and a second reactor unit 1433b. The stage has a hydrogen separator 1439, a collection unit 1440, as well as, other components as labeled on the drawing and as taught and disclosed in this specification. It being understood that any of the configurations of synthesis stages of the present systems and Examples could be used in stage 1402.

This stage 1402 can be positioned near a tank, storage container, or source of syngas and process that syngas into methanol.

### Example 19

In a preferred embodiment, the reformer in the flare gas to methanol system, (e.g., an air breathing reciprocating engine) is always run rich at wide-open throttle (WOT) when making syngas. The engine is run at WOT to improve the engine rich limit by elevating intake charge temperatures and pressures, which makes the mixture more reactive. However, running the engine at a fixed throttle opening disallows using the throttle as the primary means of engine speed control, which is typical of almost all spark ignition engines. In this embodiment, engine speed control is instead achieved by coupling the engine reformer to an electrical generator and converting the engine shaft power to electrical power. This power is then used to first power nearby equipment, and then the remainder of power required to control engine speed at the desired setpoint is sent to a variable electrical load bank. The desired engine speed can be changed by the system level controller to achieve various system goals, so power electronics may be used to transform the power generated by the engine reformer generator into useful electrical power for powering downstream equipment. The system level controller can control the power sent to the load bank, and, if necessary, prioritize turning on or off nearby equipment. If the resolution of load in the load bank is too large (5-10 kW is common) for adequate steady-state speed control, then the smallest load of the load bank can either be rapidly switched on and off at a frequency that achieves the desired engine speed, or the smallest load can be turned off and the engine control unit (ECU) can then fine tune the engine speed. This could be done via small changes in spark timing or a small reduction in throttle opening, and would prevent rapid load switching in the load bank. The system level controller could control load by using any type of feedback controller, such as a proportional integral (PI) controller. To prevent rapid load switching, the control gains on this controller could have a dead band (zero gain) or sick band (reduced gain) when asymptotically approaching the desired engine speed. This would allow fine tuning of the engine speed control with variations in spark timing and throttle opening, as previously described, without any conflict between multiple controllers all trying to achieve the same goal. The changes in spark timing and throttle opening would be sufficiently small to not significantly alter the rich limit of the engine reformer and cause subsequent operability issues. The desired engine speed determined by the system level controller can also be changed at any time to prioritize certain system level goals, such as: match syngas flowrate produced by engine to flowrate desired by downstream process, increase engine speed to produce more electrical power.

### Example 20

In an embodiment, the flywheel of the engine reformer was mechanically connected to a 200 kW 3-phase/460 Volt AC electrical generator. The electrical output of the generator was connected to the input of a 200 kW load bank. The load bank is made up of many different individual resistors ranging from 5 kW up to 100 kW, which could all be switched on or off independently, as commanded by a programmable controller. The programmable controller uses basic PI control to determine how much load is required from the load bank to make the engine reformer crankshaft speed equal the current engine speed demand. A downstream algorithm calculates the best combination of discrete resistors to turn on to closely match the desired load request from the PI controller. Solid-state relays are used to turn each resistor on or off. As this system is completely feedback based (no open-loop portion) any disturbances are quickly rejected. This is important for the commercial application of this engine reformer system, as the bulk of the electrical power produced by the generator will be used to power downstream equipment. The completely feedback controlled nature of this system will allow the controller to easily accommodate large swings in downstream load variation induced by this equipment. While the engine speed controller uses the load bank to control engine speed, the engine electronic control unit (ECU) has full control of all engine actuators, to ensure the engine reformer is producing high quality syngas and sufficient margin to all operability limits. ECU engine control includes close-loop PI control of fuel flow, based on feedback from a lambda sensor, as well as open-loop control of spark timing.

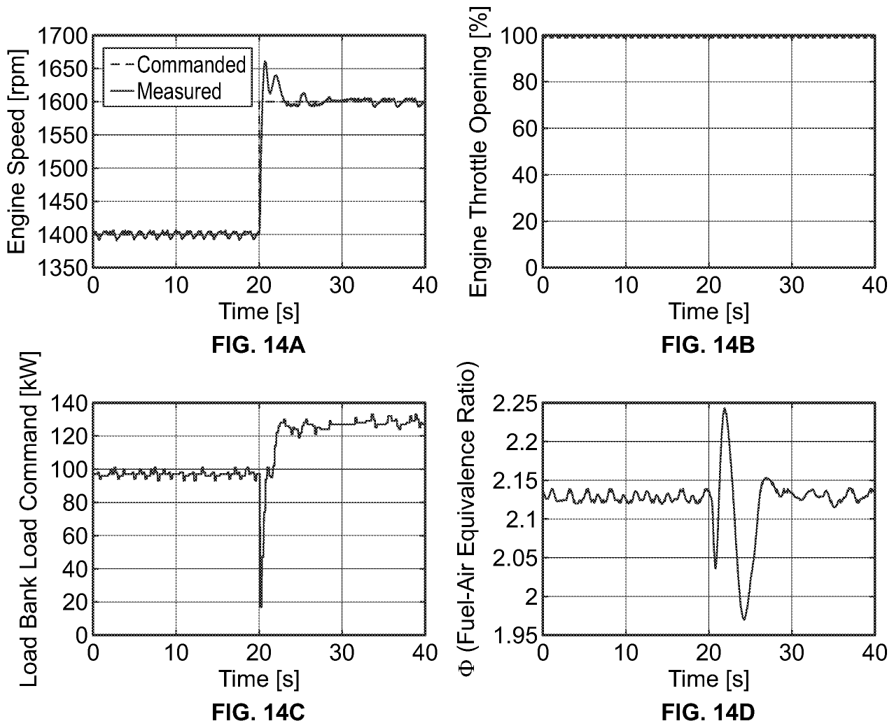

The engine reformer is operated at wide-open-throttle (WOT) and near MBT spark timing, to increase the rich operating limit of the engine. Experiments were conducted to validate the load bank-based engine speed control of the engine reformer at WOT and a fuel-air equivalence ratio of 2.13. The engine was allowed to warm-up and achieve thermal steady-state before the experiment began and the engine speed controller was also allowed to settle to steady-state with a commanded engine speed of 1400 rpm. Steady-state tracking error of the engine speed controller was computed, and then the controller step response was evaluated by instantaneously changing the commanded engine speed twenty seconds after the start of the experiment. FIGS. 14A to 14D show the steady state controller performance, as well as the step response when commanded engine speed was changed from 1400 rpm to 1600 rpm. Despite the relatively coarse minimum 5 kw resolution of the load bank used, impressive steady-state tracking performance was achieved, with a steady-state RMS error of 3.9 rpm. This is achieved by rapidly switching the 5 kW resistor on and off, to maintain fine engine speed control. This rapid switching in load bank load command can also be seen in FIG. 14C and is what causes the small ripples in engine speed at steady-state shown in FIG. 14A. Since the load bank has solid-state relays, this rapid switching won't lead to premature failure of the relays often observed when similar strategies are used with mechanical relays.

This load bank based speed control, as shown in FIGS. 14A to 14D exhibited surprisingly impressive steady-state and transient performance during testing.

The 200 rpm increase in commanded engine speed at twenty seconds only lead to a transient overshoot of 4.4% (61 rpm), before very quickly settling to resume good tracking performance, as shown in FIG. 14A. During this step response, the engine throttle opening remained at WOT and the fuel-air equivalence ratio was held very close to the targeted 2.13 by the closed loop fuel controller, as shown in FIGS. 14B and 14D, respectively. At the moment the commanded engine speed is increased, load bank load command is reduced, to allow the engine to accelerate, before quickly being increased to a level greater than before the step input, as the engine produces more power at the new higher speed.

It is noted that there is no requirement to provide or address the theory underlying the novel and groundbreaking production rates, performance or other beneficial features and properties that are the subject of, or associated with, embodiments of the present inventions. Nevertheless, various theories are provided in this specification to further advance the art in this important area, and in particular in the important area of hydrocarbon exploration, production and downstream conversion. These theories put forth in this specification, and unless expressly stated otherwise, in no way limit, restrict or narrow the scope of protection to be afforded the claimed inventions. These theories many not be required or practiced to utilize the present inventions. It is further understood that the present inventions may lead to new, and heretofore unknown theories to explain the conductivities, fractures, drainages, resource production, chemistries, and function-features of embodiments of the methods, articles, materials, devices and system of the present inventions; and such later developed theories shall not limit the scope of protection afforded the present inventions.

The various embodiments of devices, systems, activities, methods and operations set forth in this specification may be used with, in or by, various processes, industries and operations, in addition to those embodiments of the Figures and disclosed in this specification. The various embodiments of devices, systems, methods, activities, and operations set forth in this specification may be used with: other processes industries and operations that may be developed in the future: with existing processes industries and operations, which may be modified, in-part, based on the teachings of this specification; and with other types of gas recovery systems and methods. Further, the various embodiments of devices, systems, activities, methods and operations set forth in this specification may be used with each other in different and various combinations. Thus, for example, the configurations provided in the various embodiments of this specification may be used with each other. For example, the components of an embodiment having A, A′ and B and the components of an embodiment having A″, C and D can be used with each other in various combination, e.g., A, C, D, and A, A″ C and D, etc., in accordance with the teaching of this specification. Thus, the scope of protection afforded the present inventions should not be limited to a particular embodiment, configuration or arrangement that is set forth in a particular embodiment, example, or in an embodiment in a particular Figure.

The invention may be embodied in other forms than those specifically disclosed herein without departing from its spirit or essential characteristics. The described embodiments are to be considered in all respects only as illustrative and not restrictive.

1. A method of converting a gas to an end product, the method comprises:
a. receiving a flow of a hydrocarbon-based fuel source, where the composition is primarily gaseous hydrocarbons and inert gases from a source;
b. processing the fuel source in a fuel conditioning system to remove liquids and contaminants harmful to a downstream component, thereby providing a conditioned fuel source;
c. partially oxidizing the conditioned fuel source in a rich-burn, air-breathing reciprocating engine to produce a syngas mixture with a H₂/CO ratio suitable for synthesis of liquids;
d. the reciprocating engine comprising:
i. a sensor system to detect ignition/combustion behavior over a range from pre-ignition to misfire; and,
ii. a fast-acting control system in control communication with the sensor system, configured to operate the engine under rich fuel conditions.

2. A system for converting a gas to an end product, the system comprises:
a. an inflow port for receiving a flow of a hydrocarbon-based fuel source, where the composition is primarily gaseous hydrocarbons and inert gases from a source;
b. the inflow port in fluid commination with a fuel conditioning system to remove liquids and contaminants harmful to a downstream component, thereby providing a conditioned fuel source;
c. the fuel conditioning system in fluid communication with a rich-burn, air-breathing reciprocating engine, whereby the engine is configured to partially oxidize the conditioned fuel source to produce a syngas mixture with a H₂/CO ratio suitable for synthesis of liquids;
d. the reciprocating engine comprising a means to control operation under rich burning fuel conditions.

3. The systems and methods of claim 1 or 2, wherein the hydrocarbon-based fuel source is a flare gas or non-economic gas.

4. The systems and methods of claim 1 or 2, wherein the engine is a compression ignition engine including a diesel cycle engine, or homogeneous charge compression ignition engine.

5. The systems and methods of claim 1 or 2, wherein the engine is a spark ignition engine including an otto cycle.

6. The systems and methods of claim 1 or 2, wherein the engine is an opposed-piston linear-free-piston internal combustion engine.

7. The systems and methods of claim 1 or 2, wherein the engine is a crankshaft-driven opposed-piston internal combustion engine with a crankshaft phaser to rotate the phasing of one piston relative to the other thereby modifying overall compression ratio.

8. The systems and methods of claim 1 or 2, wherein the engine is a conventional spark-ignited reciprocating engine that achieves variable ‘effective’ compression ratio utilizing camshaft phasers to rotate the intake and exhaust camshafts to affect valve opening and closing.

9. The systems and methods of claim 1 or 2, wherein the engine is a conventional spark-ignited reciprocating engine that achieves variable ‘effective’ compression ratio utilizing a variable lift and/or duration valvetrain to affect valve opening and closing.

10. The systems and methods of claim 1 or 2, wherein the engine comprises a multi-link system in place of a traditional connecting rod to rotate the crankshaft, and an actuator motor changes the multi-link system endpoint.

11. The systems and methods of claim 1 or 2, wherein the engine is a 2-stroke engine.

12. The systems and methods of claim 1 or 2, wherein a 4-stroke engine.

13. The systems and methods of claim 1 or 2, wherein the engine speed is varied together with engine compression ratio to achieve desired combustion phasing and desired exhaust gas composition.

14. The systems and methods of claim 1 or 2, wherein the inlet manifold air temperature is varied together with engine compression ratio to achieve desired combustion phasing and desired exhaust gas composition.

15. The systems and methods of claim 1 or 2, wherein the inlet manifold air pressure is varied together with engine compression ratio to achieve desired combustion phasing and desired exhaust gas composition.

16. The systems and methods of claim 1 or 2, wherein steam or hydrogen is added to the incoming air or fuel and the amount of addition is varied together with engine compression ratio to achieve desired combustion phasing and desired exhaust gas composition.

17. The systems and methods of claim 1 or 2, wherein the control system uses one or more of feedback control, feed-forward control or model-based control using a physics-based engine model.

18. The method of claim 1, wherein where the engine is operated under an ER of at least 1.5.

19. The method of claim 1, wherein the engine is operated under an ER of at least about 2.

20. The method of claim 1, wherein the engine is operated under an ER of at least about 2.5.

21. The method of claim 1, wherein the engine is operated under an ER of at least about 3.

22. The method of claim 1, wherein the engine is operated under an ER of from about at least about 2.5.

23. The method of claim 1, wherein a compression ratio is controlled between a ratio of 8:1 to 14:1.

24. The system of claim 2, comprising downstream of the syngas engine a combination of integrated heat exchangers, compression system components, and heat exchangers to prepare the syngas for the downstream synthesis reactors.

25. The system of claim 2, comprising downstream of the syngas engine a downstream synthesis reactor system to produce useful liquid products.

26. The system of claim 2, comprising downstream of the syngas engine there is a downstream synthesis reactor system to produce useful gaseous products.

27. The system of claim 2, comprising a cloud-based remote monitoring system, including AI-trained anomaly detection, to dynamically monitor engine data to assess and respond to fuel supply anomalies.

28. The method of claim 1, wherein from a CO₂e life-cycle-assessment perspective, results in negative CO₂e emissions of about 40 kg CO₂e per kg of end product, compared to baseline liquid methanol production from pipeline natural gas, when produced from flare gas.

29. The method of claim 1, wherein from a CO₂e life-cycle-assessment perspective, results in negative CO₂e emissions of about 40 kg CO₂e per kg of end product, compared to baseline liquid methanol production from pipeline natural gas, when produced from flare gas; and, wherein the resulting negative CO₂e emissions are about 70 kg CO₂e per kg of end product when produced from flare gas and displacing an equivalent kg of baseline methanol from pipeline natural gas.

30. The method of claim 1, wherein from a CO₂e life-cycle-assessment perspective, results in negative CO₂e emissions of about 40 kg CO₂e per kg of end product, compared to baseline liquid methanol production from pipeline natural gas, when produced from flare gas; and, wherein the resulting negative CO₂e emissions are about 130 kg CO₂e per kg of end product when produced from flare gas and displacing an equivalent kg of baseline methanol from coal gasification.

31. The method of claim 1, wherein the end product comprises methanol.

32. The method of claim 1, wherein the end product comprises a material selected for the group consisting of ethanol, mixed alcohols, ammonia, dimethyl-ether, and F-T liquids.

33. The method of claim 1, wherein the source of the flare gas is a hydrocarbon well.

34. The method of claim 1, wherein the source of the flare gas is an oil well.

35. The method of claim 1, wherein the source of the flare gas is an unconventional oil well.

36. The method of claim 1, wherein the source of the flare gas is selected from the group consisting of petrochemical processing, refining, landfills, wastewater treatment, and livestock.

37. The method of claim 1, wherein the flow of the flare gas from the source is at a rate of about 300,000 scfd to about 30,000,000 scfd.

38. The method of claim 1, wherein the flow of the flare gas from the source is at a rate of about 50,000 scfd to about 300,000 scfd.

39. The method of claim 1, wherein the flow of the flare gas from the source is at a rate of about 500,000 scfd to about 20,000,000 scfd.

40. The method of claim 1, wherein the flow of the flare gas from the source is at a rate of about 600,000 scfd to about 15,000,000 scfd.

41. The method of claim 1, wherein the flow of the flare gas from the source is at a rate of about 700,000 scfd to about 10,000,000 scfd.

42. The system of claim 2, comprising a gas conditioning system; and, wherein the gas conditioning system removes iron sulfides.

43. The system of claim 2, comprising a gas conditioning system; and, wherein the flare gas conditioning system removes H₂S.

44. The system of claim 2, comprising a gas conditioning system; and, wherein the gas conditioning system removes sulfur containing compounds.

45. The system of claim 2, wherein the engine comprises a variable compression ratio.
